(19) United States
(12) Patent Application Publication
(10) Pub. No.: US 2025/0042130 A1
(43) Pub. Date: Feb. 6, 2025

(54) LAMINATE, MANUFACTURING METHOD OF SAME, DECORATIVE FILM, ARTICLE, DECORATIVE PANEL, AND DISPLAY DEVICE

(71) Applicant: FUJIFILM Corporation, Tokyo (JP)

(72) Inventors: Akihiro ISHII, Kanagawa (JP); Jun WATANABE, Kanagawa (JP)

(73) Assignee: FUJIFILM Corporation, Tokyo (JP)

(21) Appl. No.: 18/769,321

(22) Filed: Jul. 10, 2024

Related U.S. Application Data
(63) Continuation of application No. PCT/JP2023/006585, filed on Feb. 22, 2023.

(30) Foreign Application Priority Data
Feb. 25, 2022 (JP) 2022-028648

(51) Int. Cl. B32B 7/023; B32B 7/06; B32B 7/12; B32B 27/06

(52) U.S. Cl. CPC B32B 7/023; B32B 7/06; B32B 7/12; B32B 27/06; B32B 2305/55; B32B 2307/416; B32B 2307/546; B32B 2307/7376; B32B 2451/00

(57) ABSTRACT

Provided are a laminate including, in the following order: a substrate, an adhesive layer, and a first cured liquid crystal layer that is formed by curing a liquid crystal layer containing a cholesteric liquid crystal compound, in which a storage elastic modulus E1 of the substrate at 25° C., a storage elastic modulus E2 of the adhesive layer at 25° C., and a storage elastic modulus E3 of the first cured liquid crystal layer at 25° C. satisfy E1≥E3>E2, and the E2 is 1.0×10⁵ Pa to 1.0×10⁹ Pa; and a manufacturing method of the same, as well as a decorative film, an article, a decorative panel, and a display device that use the laminate.

### CROSS-REFERENCE TO RELATED APPLICATIONS

This application is a continuation application of International Application No. PCT/JP2023/006585, filed Feb. 22, 2023, the disclosure of which is incorporated herein by reference in its entirety. Further, this application claims priority from Japanese Patent Application No. 2022-028648, filed Feb. 25, 2022, the disclosure of which is incorporated herein by reference in its entirety.

### BACKGROUND OF THE INVENTION

### 1. Field of the Invention

The present disclosure relates to a laminate, a manufacturing method of the same, a decorative film, an article, a decorative panel, and a display device.

### 2. Description of the Related Art

For example, the following techniques are known as techniques relating to a laminate using a cholesteric liquid crystal.

WO2020/262474A discloses a decorative film for molding including a plastic substrate and a reflective layer that is provided on the plastic substrate and has a central wavelength of a selective reflection wavelength in a range of 380 nm or more and 780 nm or less, in which an elastic modulus of the reflective layer at a temperature of a glass transition point of the plastic substrate+10° C. is 0.00001 GPa or more and 0.5 GPa or less.

WO2020/175527A discloses a laminate including a protective layer, a substrate, a reflective layer having a maximum reflection wavelength in a wavelength range of 380 nm to 2,000 nm, and a pressure sensitive adhesive layer in this order, in which, in a case where an elastic modulus of the protective layer is defined as E1, an elastic modulus of the substrate is defined as E2, and an elastic modulus of the pressure sensitive adhesive layer is defined as E3, a relationship of E1≥E2>E3 is satisfied.

WO2017/018468A discloses a cholesteric resin laminate including a substrate, an interlayer, and a cholesteric resin layer in this order, in which a difference in central wavelength of a reflection band of the cholesteric resin layer before and after heating the laminate at 130° C. for 8 hours is 50 nm or less.

### SUMMARY OF THE INVENTION

An object to be achieved by an embodiment of the present disclosure is to provide a laminate having excellent bending resistance and a manufacturing method of the same.

An object to be achieved by another embodiment of the present disclosure is to provide a decorative film, an article, a decorative panel, and a display device, each using the above-described laminate.

The means for achieving the foregoing objects include the following aspects.
<1> A laminate comprising, in the following order: a substrate: an adhesive layer; and a first cured liquid crystal layer that is formed by curing a liquid crystal layer containing a cholesteric liquid crystal compound, in which a storage elastic modulus E1 of the substrate at 25° C., a storage elastic modulus E2 of the adhesive layer at 25° C., and a storage elastic modulus E3 of the first cured liquid crystal layer at 25° C. satisfy E1≥E3>E2, and the E2 is 1.0×10⁵ Pa to 1.0×10⁹ Pa.
<2> The laminate according to <1>, in which a storage elastic modulus of the first cured liquid crystal layer in an entire range of 25° C. to 80° C. is 1.0×10⁸ Pa or more.
<3> The laminate according to <1> or <2>, in which a thickness of the adhesive layer is 3 μm or more and 30 μm or less.
<4> The laminate according to any one of <1> to <3>, further comprising a second cured liquid crystal layer.
<5> The laminate according to any one of <1> to <4>, in which the laminate has at least one reflection band having a maximal value of a reflectivity in a wavelength range of 300 nm or more and 900 nm or less.
<6> The laminate according to <5>, in which the maximal value of the reflectivity in the reflection band is 40% or more.
<7> The laminate according to any one of <1> to <6>, in which a crosslinking density of a polymerizable group in the first cured liquid crystal layer is 0.8 mol/L or more.
<8> A manufacturing method of a laminate, the method comprising, in the following order: preparing a composition including a liquid crystal compound having a polymerizable group, an optically active compound, and a photopolymerization initiator; applying the composition onto a peelable substrate; curing the composition with light to form a first cured liquid crystal layer; and laminating the first cured liquid crystal layer on another substrate through an adhesive layer, in which a storage elastic modulus E1 of the substrate at 25° C., a storage elastic modulus E2 of the adhesive layer at 25° C., and a storage elastic modulus E3 of the first cured liquid crystal layer at 25° C. satisfy E1≥E3>E2, and the E2 is 1.0×10⁵ Pa to 1.0×10⁹ Pa.
<9> A decorative film comprising the laminate according to any one of <1> to <7>.
<10> An article comprising the laminate according to any one of <1> to <7>.
<11> A decorative panel comprising the decorative film according to <9>.
<12> A display device comprising the decorative panel according to <11>.

According to an embodiment of the present disclosure, it is possible to provide a laminate having excellent bending resistance and a manufacturing method of the same.

According to another embodiment of the present disclosure, it is possible to provide a decorative film, an article, a decorative panel, and a display device, each using the above-described laminate.

### DESCRIPTION OF THE PREFERRED EMBODIMENTS

Hereinafter, the laminate according to the present disclosure will be described. However, the present disclosure is not limited to the following embodiments, and can be implemented with appropriate modification within the scope of the object of the present disclosure. In a case where the embodiments of the present disclosure are described with reference to the drawings, the description of overlapping constituent elements and reference numerals may be omitted. The constituent elements indicated by the same reference numeral in the drawings mean the same constituent elements. A dimensional ratio in the drawings does not necessarily represent the actual dimensional ratio.

In a case where substitution or unsubstitution is not noted in regard to the notation of a “group” (atomic group) in the present disclosure, the “group” includes not only a group not having a substituent but also a group having a substituent. For example, an “alkyl group” includes not only an alkyl group having no substituent (unsubstituted alkyl group), but also an alkyl group having a substituent (substituted alkyl group).

In the present disclosure, “light” means an actinic ray or radiation.

In the present disclosure, “actinic ray” or “radiation” refers to, for example, a bright line spectrum of a mercury lamp, far ultraviolet rays typified by excimer lasers, extreme ultraviolet rays (EUV light), X-rays, or electron beams (EB).

In the present disclosure, unless otherwise specified, “exposure” includes not only exposure by a bright line spectrum of a mercury lamp, far ultraviolet rays typified by excimer lasers, extreme ultraviolet rays, X-rays, EUV light, or the like, but also exposure by corpuscular beams such as electron beams and ion beams.

In the present disclosure, “to” is used to refer to a meaning including numerical values denoted before and after “to” as a lower limit value and an upper limit value, respectively.

In the present disclosure, (meth)acrylate represents acrylate and methacrylate, and (meth)acrylic represents acrylic and methacrylic.

In the present disclosure, a weight-average molecular weight (Mw), a number-average molecular weight (Mn), and a dispersity (also referred to as molecular weight distribution) (Mw/Mn) of a resin component are defined as values in terms of polystyrene according to a gel permeation chromatography (GPC) measurement (solvent: tetrahydrofuran, flow volume (sample injection volume): 10 μL, column: TSK gel Multipore HXL-M manufactured by Tosoh Corporation, column temperature: 40° C., flow velocity: 1.0 mL/min, detector: refractive index detector) using a GPC device (HLC-8120GPC manufactured by Tosoh Corporation).

In the present disclosure, in a case where a plurality of substances corresponding to each component are present in a composition, the amount of each component in the composition means a total amount of the plurality of corresponding substances present in the composition, unless otherwise specified.

In the disclosure of the present specification, the term “step” includes not only an individual step but also a step which is not clearly distinguishable from another step as long as an effect expected from the step can be achieved.

In the present disclosure, the “total solid content” refers to a total mass of components excluding a solvent from the whole composition of the composition. In addition, the “solid content” is a component excluding a solvent from the whole composition of the composition, and may be solid or liquid at 25° C., for example.

In the present disclosure, the “% by mass” has the same definition as that for “% by weight”, and the “part by mass” has the same definition as that for “part by weight”.

In addition, in the present disclosure, a combination of two or more preferred aspects is a more preferred aspect.

### <Laminate>

The laminate according to the present disclosure is a laminate including, in the following order, a substrate, an adhesive layer, and a first cured liquid crystal layer that is formed by curing a liquid crystal layer containing a cholesteric liquid crystal compound, in which a storage elastic modulus E1 of the substrate at 25° C., a storage elastic modulus E2 of the adhesive layer at 25° C., and a storage elastic modulus E3 of the first cured liquid crystal layer at 25° C. satisfy E1≥E3>E2, and the E2 is 1.0×10⁵ Pa to 1.0×10⁹ Pa.

The related art laminate having a cured liquid crystal layer has a problem in that the laminate does not have sufficient resistance to bending and the cured liquid crystal layer is likely to be cracked.

As a result of extensive studies conducted by the present inventors, the present inventors have found that a laminate having excellent bending resistance can be obtained by adopting the above-described aspect.

With regard to the laminate, it is presumed that, by setting such that the storage elastic modulus E1 of the substrate at 25° C., the storage elastic modulus E2 of the adhesive layer at 25° C., and the storage elastic modulus E3 of the first cured liquid crystal layer at 25° C. satisfy E1≥E3>E2, and the E2 is 1.0×10⁵ Pa to 1.0×10⁹ Pa, a difference in strain between the first cured liquid crystal layer and the adhesive layer in a case where stress is applied, such as bending, is suppressed to a small level, the followability of the first cured liquid crystal layer to the substrate is improved, and therefore a laminate having excellent bending resistance is obtained.

### [Storage Elastic Modulus of Each Layer and Relationship Thereof]

In the laminate according to the present disclosure, it is preferable that the storage elastic modulus E1 of the substrate at 25° C., the storage elastic modulus E2 of the adhesive layer at 25° C., and the storage elastic modulus E3 of the first cured liquid crystal layer at 25° C. satisfy E1≥E3>E2, and from the viewpoint of bending resistance, E1>E3>E2.

From the viewpoint of bending resistance, the storage elastic modulus E1 of the substrate at 25° C. is preferably 1.0×10⁸ Pa to 1.0×10¹¹ Pa, more preferably 1.0×10⁹ Pa to 5.0×10¹⁰ Pa, still more preferably 2.0×10⁹ Pa to 2.0×10¹⁰ Pa, and particularly preferably 3.0×10⁹ Pa to 1.0×10¹⁰ Pa.

The storage elastic modulus E2 of the adhesive layer at 25° C. is 1.0×10⁵ Pa to 1.0×10⁹ Pa. From the viewpoint of bending resistance and durability; the storage elastic modulus E2 is preferably 2.0×10⁸ Pa to 8.0×10⁸ Pa and more preferably 4.0×10⁸ Pa to 6.0×10⁸ Pa.

From the viewpoint of bending resistance and durability, the storage elastic modulus E3 of the first cured liquid crystal layer at 25° C. is preferably 1.0×10⁷ Pa to 1.0×10¹¹ Pa, more preferably 1.0×10⁸ Pa to 5.0×10¹⁰ Pa, still more preferably 5.0×10⁸ Pa to 1.0×10¹⁰ Pa, and particularly preferably 1.0×10⁹ Pa to 5.0×10⁹ Pa.

In addition, from the viewpoint of bending resistance, the storage elastic modulus of the first cured liquid crystal layer is preferably 1.0×10⁷ Pa or more, more preferably 1.0×10⁸ Pa or more, still more preferably 1.0×10⁸ Pa to 1.0×10¹⁰ Pa, and particularly preferably 2.0×10⁹ Pa to 5.0×10⁹ Pa, in the entire range of 25° C. to 80° C.

Further, from the viewpoint of bending resistance, the storage elastic modulus of the first cured liquid crystal layer at 80° C. is preferably 1.0×10⁶ Pa to 1.0×10¹¹ Pa, more preferably 1.0×10⁷ Pa to 5.0×10¹⁰ Pa, and still more preferably 1.0×10⁸ Pa to 1.0×10¹⁰ Pa.

From the viewpoint of bending resistance, the storage elastic modulus of the first cured liquid crystal layer at 80° C. is preferably larger than the E2.

In addition, from the viewpoint of bending resistance and durability, the value of E1-E3 is preferably 0 Pa or more and 5.0×10¹⁰ Pa or less, more preferably more than 0 Pa and 1.0×10¹⁰ Pa or less, still more preferably 1.0×10⁷ Pa or more and 8.0×10⁹ Pa or less, and particularly preferably 1.0×10⁸ Pa or more and 5.0×10⁹ Pa or less.

Further, from the viewpoint of bending resistance and durability, the value of E3/E2 is preferably 1.5 to 10⁵, more preferably 2 to 103, still more preferably 2 to 102, and particularly preferably 2 to 10.

The storage elastic modulus of each layer in the present disclosure is measured in such a manner that each sample of 5 mm×25 mm is subjected to humidity conditioning at a temperature of 25° C. and a relative humidity of 60% for 2 hours or longer, and then the storage elastic modulus of each layer is measured using a dynamic viscoelasticity measuring device (VIBRON: DVA-225, manufactured by IT Measurement Control Co., Ltd.) at a distance between grips of 10 mm, a temperature increase rate of 5° C./min, a measurement temperature range of −100° C. to 200° C., and a frequency of 10 Hz.

The measurement of each layer may be carried out on a cut cross section of the laminate, may be carried out by exposing a layer to be measured by cutting or the like, or may be carried out on a surface of the laminate.

### [Reflection Band]

The laminate preferably has selective reflectivity and more preferably has a reflection band in a part of a wavelength range.

Above all, from the viewpoint of lustrousness and designability; the laminate preferably has at least one reflection band having a maximal value of a reflectivity in a wavelength range of 300 nm or more and 900 nm or less, more preferably has at least one reflection band having a maximal value of a reflectivity in a wavelength range of 400 nm or more and 700 nm or less, and particularly preferably has at least one reflection band having a maximal value of a reflectivity in a wavelength range of 500 nm or more and 600 nm or less.

In addition, from the viewpoint of lustrousness and designability, the maximal value of the reflectivity in the reflection band is preferably 20% or more, more preferably 30% or more, still more preferably 40% or more, and particularly preferably 45% or more.

In the present disclosure, the reflectivity (reflection band, maximal value of reflectivity) of the laminate is measured as follows.

Using a spectrophotometer (for example, V-670) manufactured by JASCO Corporation) equipped with a large integrating sphere device (for example, ILV-471 manufactured by JASCO Corporation), light having a wavelength of 300 nm to 900 nm is incident from a vertical direction (at an angle of 90° with respect to the surface of the first cured liquid crystal layer), and the reflectivity is obtained from the obtained spectroscopic spectrum.

### [Substrate]

The laminate according to the present disclosure has a substrate.

Examples of the substrate include a substrate used for molding such as three-dimensional molding and insert molding. From the viewpoint of ease of molding and chipping resistance, the substrate is preferably a resin substrate and preferably a resin film.

Examples of the resin include polyethylene terephthalate (PET), polyethylene naphthalate (PEN), an acrylic resin, a urethane resin, a urethane-acrylic resin, polycarbonate (PC), acrylic-polycarbonate, polyolefin, triacetyl cellulose (TAC), a cycloolefin polymer (COP), and an acrylonitrile/butadiene/styrene copolymer (ABS resin).

From the viewpoint of moldability and strength, the substrate is preferably a resin film containing at least one resin selected from the group consisting of polyethylene terephthalate, an acrylic resin, a urethane resin, a urethane-acrylic resin, polycarbonate, acrylic-polycarbonate, and polypropylene, more preferably a resin film containing at least one resin selected from the group consisting of polyethylene terephthalate, an acrylic resin, polycarbonate, and an acrylic-polycarbonate resin, and most preferably polyethylene terephthalate.

The substrate may have a monolayer structure or a multilayer structure. Examples of the preferred laminated film include an acrylic resin/polycarbonate resin laminated film.

The substrate may contain an additive, as necessary. Examples of the additive include a lubricant such as mineral oil, a hydrocarbon, a fatty acid, an alcohol, a fatty acid ester, a fatty acid amide, a metal soap, a natural wax, or silicone, an inorganic flame retardant such as magnesium hydroxide or aluminum hydroxide, an organic flame retardant such as a halogen-based flame retardant or a phosphorus-based flame retardant, an organic or inorganic filler such as metal powder, talc, calcium carbonate, potassium titanate, glass fiber, carbon fiber, or wood powder, an additive such as an antioxidant, an ultraviolet inhibitor, a glidant, a dispersant, a coupling agent, a foaming agent, or a colorant, and an engineering plastic other than the above-mentioned resins, such as a polyolefin, polyester, polyacetal, polyamide, or polyphenylene ether resin.

The substrate may be a commercially available product. Examples of the commercially available product of the substrate include TECHNOLLOY® series (acrylic resin film or acrylic resin/polycarbonate resin laminated film, Sumitomo Chemical Co., Ltd.), ABS films (Okamoto Industries, Inc.), ABS sheets (Sekisui Seikei Co., Ltd.), TEFLEX® series (PET film, Teijin Film Solutions Limited), LUMIRROR® easily moldable type (PET film, Toray Industries, Inc.), PURETHERMO (polypropylene film, Idemitsu Unitech Co., Ltd.), and COSMOSHINE® series (PET film, Toyobo Co., Ltd.).

A thickness of the substrate is preferably 1 μm or more, more preferably 10 μm or more, still more preferably 20 μm or more, and particularly preferably 50 μm or more. The thickness of the substrate is preferably 500 μm or less, more preferably 450 μm or less, and particularly preferably 200 μm or less.

The thickness and the refractive index of each layer in the present disclosure are measured, for example, by measuring a transmission spectrum of a single film of a layer to be measured, which is formed on an alkali-free glass OA-10G, using a spectrophotometer, and carrying out a fitting analysis using a transmittance obtained by the measurement of the transmission spectrum and a transmittance calculated by an optical interferometry. The refractive index may be measured using a Kalnew precision refractometer (KPR-3000, manufactured by Shimadzu Corporation).

### [Adhesive Layer]

The laminate according to the present disclosure includes an adhesive layer. The adhesive layer can improve, for example, the adhesiveness between the substrate and each layer.

The adhesive layer preferably contains an adhesive, and may further contain a component other than the adhesive.

From the viewpoint of bending resistance, the adhesive layer is preferably adjacent to the first cured liquid crystal layer.

In addition, from the viewpoint of bending resistance, the breaking elongation of the adhesive layer is preferably equal to or greater than the breaking elongation of the first cured liquid crystal layer. The ratio of the breaking elongation of the adhesive layer to the breaking elongation of the first cured liquid crystal layer is preferably 1.0 to 50, more preferably 1.5 to 30, and still more preferably 1.75 to 20.

The type of the adhesive is not limited, and the adhesive may be a known adhesive used for permanent adhesion. The adhesive may be a known adhesive used for temporary adhesion. The adhesive is preferably a component that is stretched following the first cured liquid crystal layer in molding.

Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive. From the viewpoint of high adhesive force, a urethane resin adhesive or a silicone adhesive is preferable. The adhesive may be a thermosetting adhesive. The adhesive may be an ultraviolet curable adhesive.

Examples of the adhesive include a pressure sensitive adhesive. That is, the adhesive layer may contain a pressure sensitive adhesive as an adhesive. Examples of the pressure sensitive adhesive include an acrylic pressure sensitive adhesive, a rubber-based pressure sensitive adhesive, and a silicone-based pressure sensitive adhesive. Examples of the pressure sensitive adhesive include acrylic pressure sensitive adhesives, ultraviolet (UV) curable pressure sensitive adhesives, and silicone pressure sensitive adhesives described in “Characteristic evaluation and control technique of release paper, release film, and pressure sensitive adhesive tape, published by Johokiko Co., Ltd., 2004, Chapter 2”. The acrylic pressure sensitive adhesive refers to a pressure sensitive adhesive containing a polymer of a (meth)acrylic monomer. The adhesive-containing layer may contain a viscosity imparting agent in addition to the pressure sensitive adhesive. Examples of the adhesive include UVX-6282 (manufactured by Toagosei Co., Ltd.), NCF-D692 (manufactured by Lintec Corporation), and UF-3007 (manufactured by Kyoeisha Chemical Co., Ltd.).

From the viewpoint of bending resistance, adhesiveness, and handleability, a thickness of the adhesive layer is preferably 2 μm or more and 50 μm or less, more preferably 3 μm or more and 30 μm or less, still more preferably 3 μm or more and 15 μm or less, and particularly preferably 3 μm or more and 10 μm or less.

A method of forming the adhesive layer is not limited. Examples of the method of forming the adhesive layer include a method of bonding a film having an adhesive layer and a first cured liquid crystal layer, a method of bonding a single adhesive layer and a first cured liquid crystal layer, and a method of applying a composition containing an adhesive onto a liquid crystal layer.

### [First Cured Liquid Crystal Layer]

The laminate according to the present disclosure includes a first cured liquid crystal layer formed by curing a liquid crystal layer containing a cholesteric liquid crystal compound.

The first cured liquid crystal layer is preferably a layer formed by polymerizing at least a polymerizable compound, and more preferably a layer formed by polymerizing at least an ethylenically unsaturated compound.

In addition, the first cured liquid crystal layer is preferably a cholesteric liquid crystal layer.

The “cholesteric liquid crystal layer” is a layer having an alignment state of a molecule unique to a cholesteric liquid crystal. Hereinafter, the “alignment state of a molecule unique to a cholesteric liquid crystal” may be referred to as a “cholesteric alignment state” or simply an “alignment state”. The alignment state may include an alignment state in which dextrorotatory circularly polarized light is reflected, an alignment state in which levorotatory circularly polarized light is reflected, or both of these alignment states. The alignment state may be fixed by a method such as polymerization or crosslinking.

From the viewpoint of bending resistance and durability; the crosslinking density of the polymerizable groups in the first cured liquid crystal layer is preferably 0.2 mol/L or more, more preferably 0.5 mol/L or more, still more preferably 0.8 mol/L or more, and particularly preferably 0.9 mol/L to 1.5 mol/L.

The polymerizable group is not particularly limited, and a known polymerizable group can be used, but an ethylenically unsaturated group is preferable.

In a case where the polymerizable group is an ethylenically unsaturated group, the crosslinking density of the polymerizable groups in the first cured liquid crystal layer is measured by the following method. In the measurement of the crosslinking density, FT/IR-4000 manufactured by JASCO Corporation and a measuring device equivalent thereto are used.

(1) The reaction consumption rate of a C═C double bond (that is, an ethylenically unsaturated bond) is calculated using the following calculation expression.

Expression: Reaction consumption rate={(peak intensity derived from C═C double bond before curing)−(peak intensity derived from C═C double bond after curing)}/(peak intensity derived from C═C double bond before curing)

(2) The “C═C double bond equivalent (mol/L) of a compound having two or more polymerizable groups/total C═C double bond equivalent (mol/L) of all compounds” in the liquid crystal layer is calculated from the formulation addition amount.

(3) A value obtained by multiplying the value obtained in (2) above by the value obtained in (1) above is adopted as the crosslinking density:

The first cured liquid crystal layer preferably has selective reflectivity. The “selective reflectivity” means that a selective reflection wavelength is present in a specific wavelength range. The “selective reflection wavelength” refers to an average value of two wavelengths indicating a half-value transmittance (T1/2, unit: %) represented by the following expression, in a case where a minimum value of a transmittance in a target object is defined as Tmin (%). The selective reflection wavelength of the first cured liquid crystal layer may be set in a range of, for example, visible light (380 nm to 780 nm) and near infrared light (more than 780 nm and 2,000 nm or less). The first cured liquid crystal layer preferably has selective reflectivity in at least a part of a wavelength range of 300 nm to 1,200 nm, and more preferably has selective reflectivity in at least a part of a wavelength range of 300 nm to 900 nm.

Expression: Half-value transmittance T1/2=100−(100−Tmin)/2

Examples of the components of the liquid crystal layer before curing for forming the first cured liquid crystal layer include a cholesteric liquid crystal compound, an optically active compound, a polymerization initiator, a polymerizable monomer, a polyfunctional polymerizable compound, a photoisomerization compound, a crosslinking agent, a solvent, and other additives. The aspects of the respective components are as described in the description of the components of the composition which will be described later. Examples of a preferable component of the first cured liquid crystal layer include a polymer having a constitutional unit derived from a cholesteric liquid crystal compound having a polymerizable group, a polymer having a constitutional unit derived from an optically active compound having a polymerizable group, and a polymer having a constitutional unit derived from a cholesteric liquid crystal compound having a polymerizable group and a constitutional unit derived from an optically active compound having a polymerizable group.

The first cured liquid crystal layer is preferably a cured product of a composition containing a cholesteric liquid crystal compound and an optically active compound. The composition is cured, for example, by light or heat. A preferred curing method of the composition is described in the description of the manufacturing method of a laminate which will be described later. The cured product may not contain a compound having liquid crystallinity. For example, the cured product may contain a compound having no liquid crystallinity; which is formed by polymerization or crosslinking of a cholesteric liquid crystal compound having a reactive group. Examples of the components of the composition include a cholesteric liquid crystal compound, an optically active compound, a polymerization initiator, a polymerizable monomer, a polyfunctional polymerizable compound, a photoisomerization compound, a crosslinking agent, a solvent, and other additives. The composition preferably contains a cholesteric liquid crystal compound and an optically active compound. The composition more preferably contains a cholesteric liquid crystal compound, an optically active compound, and a polymerization initiator. Hereinafter, specific aspects of each component will be described.

### (Cholesteric Liquid Crystal Compound)

The first cured liquid crystal layer in the laminate according to the present disclosure is a layer formed by curing a liquid crystal layer containing a cholesteric liquid crystal compound.

The composition preferably contains a cholesteric liquid crystal compound. The type of the cholesteric liquid crystal compound is not limited. The cholesteric liquid crystal compound may be a known cholesteric liquid crystal compound.

The cholesteric liquid crystal compound preferably has a reactive group. The reactive group is preferably a polymerizable group. Examples of the polymerizable group include a radically polymerizable group and a cationically polymerizable group. From the viewpoint of reactivity and ease of fixing a helical pitch, the cholesteric liquid crystal compound preferably has a radically polymerizable group. The radically polymerizable group is preferably at least one polymerizable group selected from the group consisting of a vinyl group, an acryloyl group, and a methacryloyl group, and more preferably at least one polymerizable group selected from the group consisting of an acryloyl group and a methacryloyl group.

The cholesteric liquid crystal compound may have two or more reactive groups. The cholesteric liquid crystal compound may have two or more types of reactive groups.

The cholesteric liquid crystal compound may be a cholesteric liquid crystal compound having two or more types of reactive groups having different crosslinking mechanisms. The crosslinking mechanism may be a condensation reaction, hydrogen bonding, or polymerization. It is preferable that at least one of the crosslinking mechanisms of the two or more types of reactive groups is polymerization. The crosslinking mechanism preferably includes two or more types of polymerizations. Examples of the reactive group used in the crosslinking mechanism as described above include a vinyl group, a (meth)acryloyl group, an epoxy group, an oxetanyl group, a vinyl ether group, a hydroxy group, a carboxy group, and an amino group.

The cholesteric liquid crystal compound having two or more types of reactive groups having different crosslinking mechanisms may be a compound that can be crosslinked in stages. At each stage, a reactive group corresponding to the crosslinking mechanism of each stage reacts.

Examples of a method for crosslinking two or more types of reactive groups in stages include a method of changing reaction conditions in each stage. Examples of the change point of the reaction conditions include a temperature, a wavelength of light (irradiation), and a polymerization mechanism. It is preferable to use a difference in polymerization mechanism from the viewpoint of easy separation of reactions. The polymerization mechanism is controlled by, for example, the type of the polymerization initiator.

The combination of polymerizable groups is preferably a combination of a radically polymerizable group and a cationically polymerizable group. From the viewpoint of easy control of reactivity, it is preferable that the radically polymerizable group is a vinyl group or a (meth)acryloyl group and the cationically polymerizable group is an epoxy group, an oxetanyl group, or a vinyl ether group as for the combination of polymerizable groups.

In addition, the polymerizable group is preferably an ethylenically unsaturated group.

From the viewpoint of stretchability and heat resistance, the cholesteric liquid crystal compound preferably includes a cholesteric liquid crystal compound having one reactive group (preferably a polymerizable group). From the viewpoint of stretchability and heat resistance, the proportion of the content of the cholesteric liquid crystal compound having one reactive group with respect to the content of the cholesteric liquid crystal compound is preferably 96% by mass to 100% by mass, more preferably 97% by mass to 100% by mass, and preferably 98% by mass to 100% by mass.

From the viewpoint of stretchability and heat resistance, the cholesteric liquid crystal compound preferably includes a cholesteric liquid crystal compound having one reactive group and a cholesteric liquid crystal compound having two or more reactive groups. The cholesteric liquid crystal compound more preferably includes a cholesteric liquid crystal compound having one reactive group and a cholesteric liquid crystal compound having two reactive groups. From the viewpoint of stretchability and heat resistance, the ratio of the content of the cholesteric liquid crystal compound having two or more reactive groups to the content of the cholesteric liquid crystal compound having one reactive group is preferably 0 to 0.05, more preferably 0 to 0.04, and preferably 0 to 0.02, on a mass basis.

Specific examples of the reactive group are shown below. In this regard, the reactive group is not limited to the following specific examples. In the following specific examples, Et represents an ethyl group, and n-Pr represents an n-propyl group.

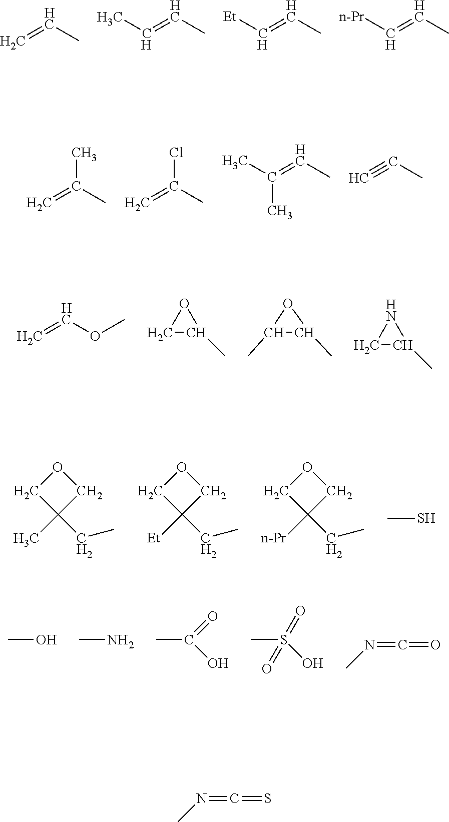

Examples of the cholesteric liquid crystal compound include a rod-like cholesteric liquid crystal compound and a disk-like cholesteric liquid crystal compound. The rod-like cholesteric liquid crystal compound may be a low-molecular-weight type compound or a polymer type compound. The disk-like cholesteric liquid crystal compound may be a low-molecular-weight type compound or a polymer type compound. In the present disclosure, the term “polymer” used for the cholesteric liquid crystal compound means a compound having a polymerization degree of 100 or more (Polymer Physics and Phase Transition Dynamics, written by Masao Doi, p. 2, Iwanami Shoten, Publishers, 1992). A mixture of two or more types of rod-like cholesteric liquid crystal compounds, a mixture of two or more types of disk-like cholesteric liquid crystal compounds, or a mixture of a rod-like cholesteric liquid crystal compound and a disk-like cholesteric liquid crystal compound may be used. In two or more types of cholesteric liquid crystal compounds, it is preferable that at least one type of cholesteric liquid crystal compound has a reactive group.

The cholesteric liquid crystal compound is preferably a rod-like cholesteric liquid crystal compound. Examples of the rod-like cholesteric liquid crystal compound include azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles. Examples of the rod-like cholesteric liquid crystal compound also include a polymer of a rod-like cholesteric liquid crystal compound having a reactive group. Examples of the rod-like cholesteric liquid crystal compound also include compounds described in JP2008-281989A, JP1999-513019A (JP-H11-513019A), and JP2006-526165A.

Specific examples of the rod-like cholesteric liquid crystal compound are shown below. In this regard, the rod-like cholesteric liquid crystal compound is not limited to the following specific examples. The compounds shown below are synthesized, for example, by the method described in JP1999-513019A (JP-H11-513019A).

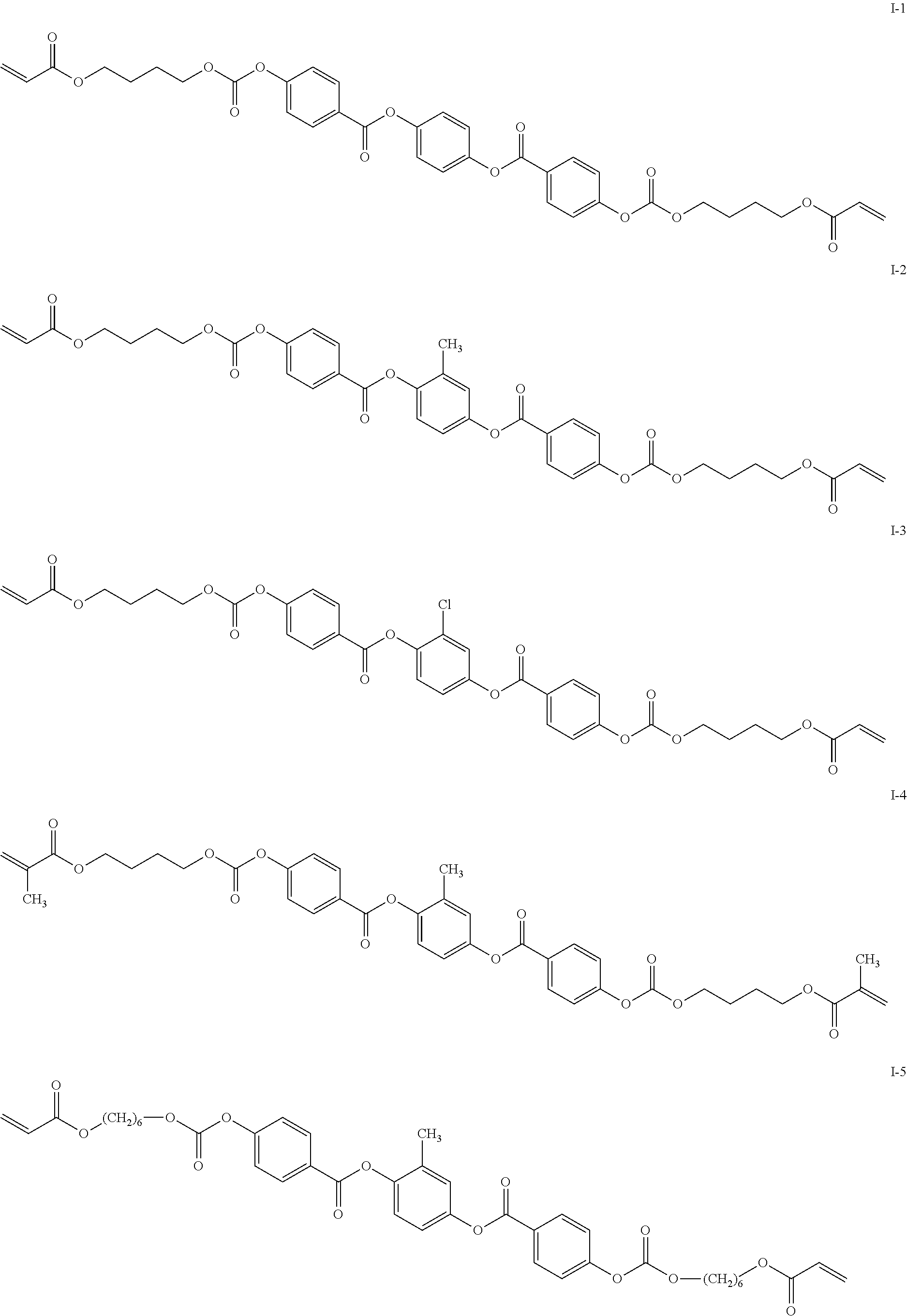

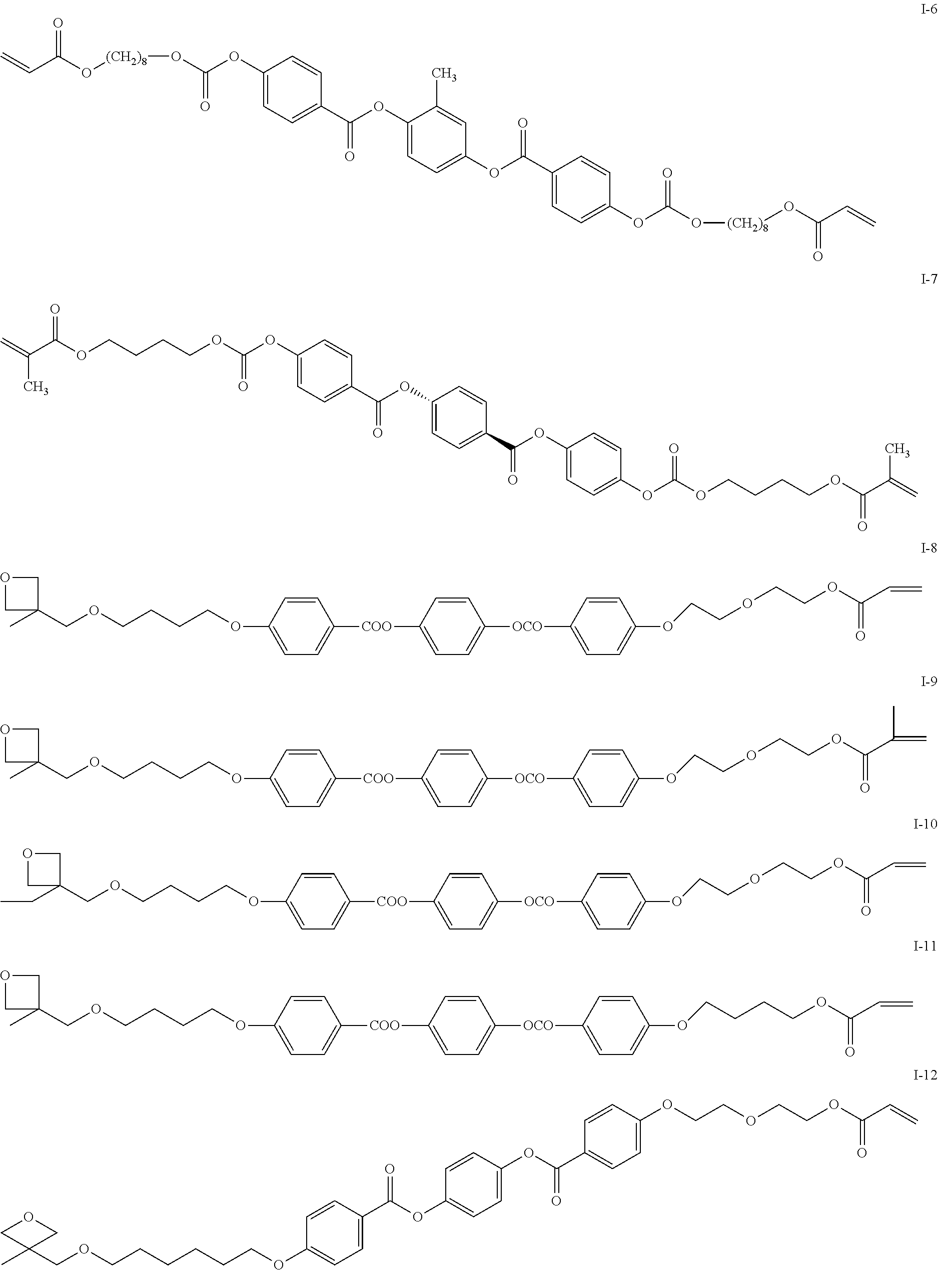

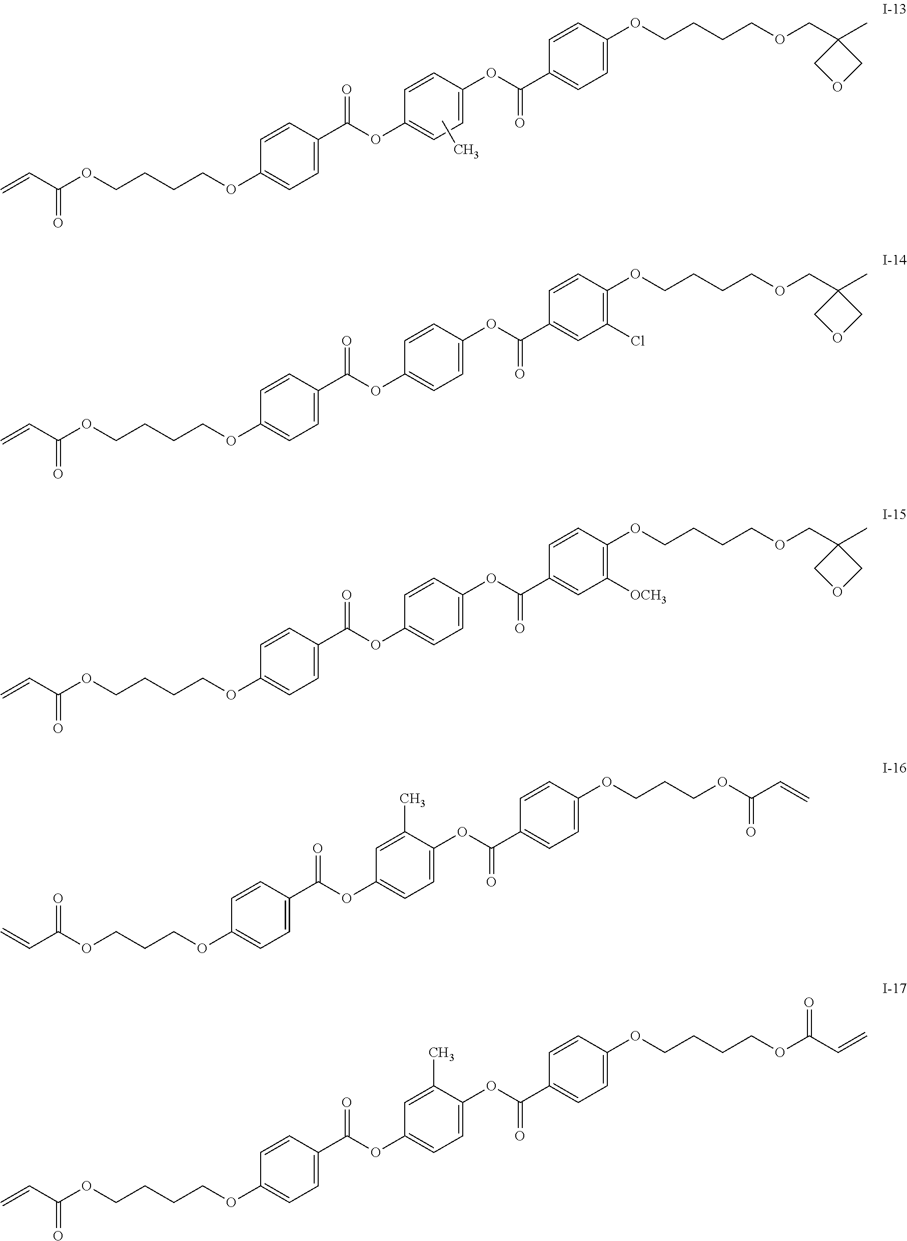

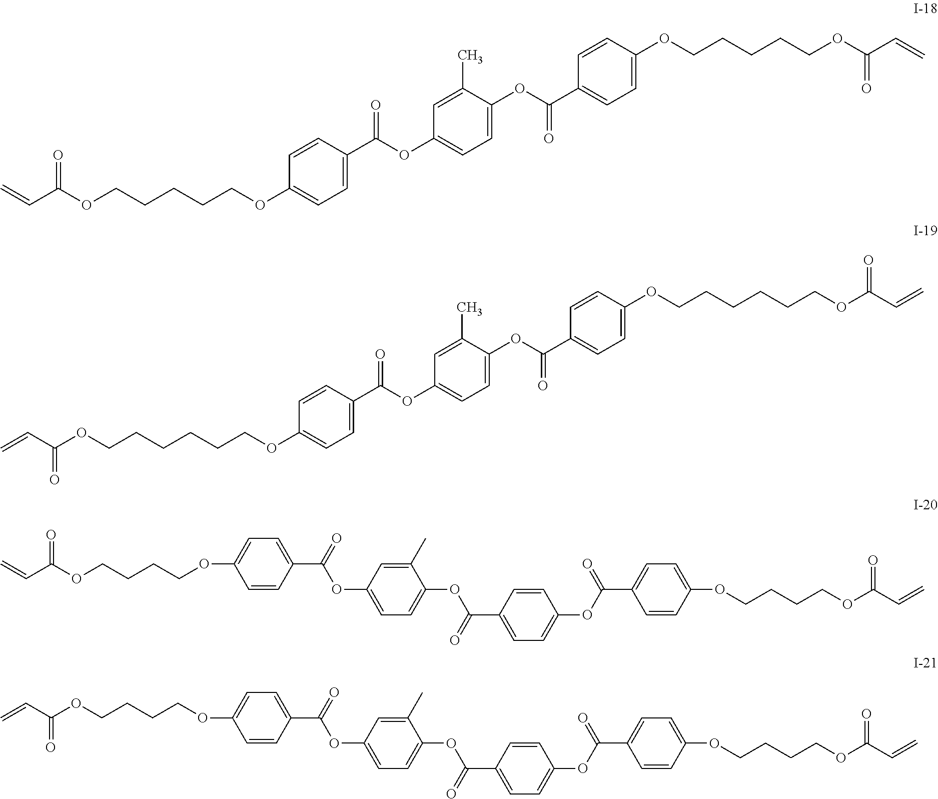

Examples of the rod-like cholesteric liquid crystal compound having one polymerizable group include the following compounds. “Me” in the following chemical formulae means a methyl group.

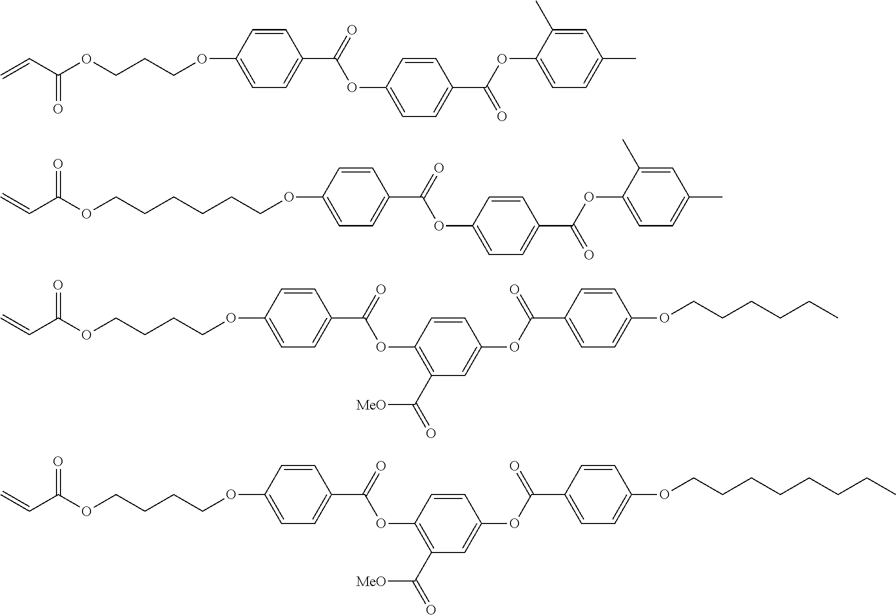

Examples of the disk-like cholesteric liquid crystal compound include the following compounds.
(1) Benzene derivatives described in a research report by C. Destrade et al., for example, Mol. Cryst. vol. 71, page 111 (1981)
(2) Truxene derivatives described in a research report by C. Destrade et al., for example, Mol. Cryst. vol. 122, p. 141 (1985) and Physics lett, A, vol. 78, p. 82 (1990)
(3) Cyclohexane derivatives described in a research report by B. Kohne et al., for example, Angew. Chem. vol. 96, p. 70 (1984)
(4) Azacrown-based or phenylacetylene-based macrocycles described in a research report by J. M. Lehn et al. (J. Chem. Commun., p. 1794 (1985)) and a research report by J. Zhang et al. (J. Am. Chem. Soc., vol. 116, p. 2655 (1994))

The disk-like cholesteric liquid crystal compound includes a liquid crystal compound, generally referred to as a disk-like liquid crystal, which has a structure in which the above-described various structures serve as a disk-like mother nucleus at the center of the molecule and groups such as a linear alkyl group, an alkoxy group, and a substituted benzoyloxy group are arranged in a radial manner, and which exhibits liquid crystallinity. In a case where an aggregate of such a compound is uniformly aligned, negative uniaxiality appears.

Examples of the disk-like cholesteric liquid crystal compound include the compounds described in paragraphs to of JP2008-281989A.

In the liquid crystal layer, the disk-like cholesteric liquid crystal compound having a reactive group may be fixed in an alignment state such as horizontal alignment, vertical alignment, tilt alignment, or twisted alignment.

The composition may contain one type of cholesteric liquid crystal compound or two or more types of cholesteric liquid crystal compounds.

The proportion of the content of the cholesteric liquid crystal compound with respect to the total mass of the solid content of the composition is preferably 30% by mass to 99% by mass, more preferably 40% by mass to 99% by mass, still more preferably 60% by mass to 99% by mass, and particularly preferably 70% by mass to 98% by mass.

### (Optically Active Compound)

The composition preferably contains an optically active compound (also referred to as a “chiral agent”). The optically active compound can induce a helical structure of a cholesteric liquid crystal. For example, the optically active compound can adjust a helical pitch.

The type of the optically active compound is not limited. The optically active compound may be a known optically active compound. The optically active compound may be selected depending on a desired helical structure. Examples of the optically active compound include the compounds described in Liquid Crystal Device Handbook (Chapter 3, Section 4-3, chiral agents for TN and STN, p. 199, edited by the 142nd Committee of Japan Society for the Promotion of Science, 1989), JP2003-287623A, JP2002-302487A, JP2002-80478A, JP2002-80851A, JP2010-181852A, and JP2014-034581A.

The optically active compound preferably has a cinnamoyl group.

The optically active compound preferably contains an asymmetric carbon atom. In this regard, the optically active compound may be an axially chiral compound or planar chiral compound which does not contain an asymmetric carbon atom. Examples of the axially chiral compound and the planar chiral compound include binaphthyl, helicene, paracyclophane, and derivatives thereof.

The optically active compound may have a reactive group. The reactive group is preferably a polymerizable group. The polymerizable group is preferably at least one polymerizable group selected from the group consisting of an ethylenically unsaturated group, an epoxy group, and an aziridinyl group, more preferably an ethylenically unsaturated group, and still more preferably at least one polymerizable group selected from the group consisting of an acryloyl group and a methacryloyl group. The optically active compound may have two or more reactive groups. The optically active compound may have two or more types of reactive groups.

From the viewpoint of stretchability and heat resistance, the optically active compound preferably includes an optically active compound having one polymerizable group. In a case where the optically active compound includes an optically active compound having one polymerizable group, the proportion of the content of the optically active compound having one polymerizable group with respect to the content of the optically active compound is preferably more than 0% by mass, more preferably 50% by mass or more, and still more preferably 70% by mass or more, from the viewpoint of stretchability and heat resistance. The upper limit of the proportion of the content of the optically active compound having one polymerizable group may be 100% by mass. The proportion of the content of the optically active compound having one polymerizable group with respect to the content of the optically active compound may be 0% by mass to 100% by mass.

The composition preferably contains a cholesteric liquid crystal compound having a polymerizable group and an optically active compound having a polymerizable group. For example, the reaction between the optically active compound having a polymerizable group and the cholesteric liquid crystal compound having a polymerizable group can form a polymer having a constitutional unit derived from the cholesteric liquid crystal compound having a polymerizable group and a constitutional unit derived from the optically active compound having a polymerizable group. It is preferable that the type of the polymerizable group in the optically active compound is the same as the type of the polymerizable group in the cholesteric liquid crystal compound.

The optically active compound may be a cholesteric liquid crystal compound.

From the viewpoint of ease of forming a liquid crystal layer, ease of adjusting a helical pitch, and bending resistance, the optically active compound may be a photoisomerization compound that also acts as the optically active compound. Examples of the photoisomerization compound that also acts as the optically active compound include a compound represented by Formula (CH1) which will be described later.

Preferred examples of the optically active compound include an isosorbide derivative, an isomannide derivative, and a binaphthyl derivative.

Specific examples of the optically active compound are shown below. In this regard, the optically active compound is not limited to the following specific examples.

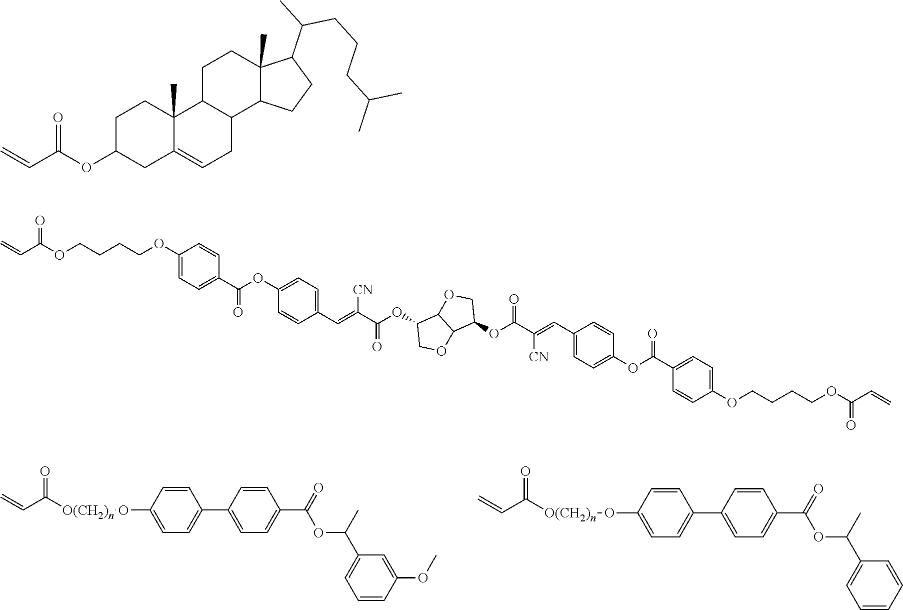

In the above chemical formulae, n represents an integer of 2 to 12. From the viewpoint of synthesis cost, n is preferably 2 or 4.

The composition may contain one type of optically active compound or two or more types of optically active compounds.

From the viewpoint of ease of forming a liquid crystal layer, ease of adjusting a helical pitch, and bending resistance, the proportion of the content of the optically active compound with respect to the total mass of the solid content of the composition is preferably 1% by mass to 20% by mass, more preferably 2% by mass to 10% by mass, still more preferably 3% by mass to 9% by mass, and particularly preferably 4% by mass to 8% by mass.

From the viewpoint of bending resistance, the proportion of the content of the optically active compound having a polymerizable group with respect to the total mass of the solid content of the composition is preferably 0.2% by mass to 15% by mass, more preferably 0.5% by mass to 10% by mass, still more preferably 1% by mass to 8% by mass, and particularly preferably 1.5% by mass to 5% by mass.

From the viewpoint of bending resistance, the proportion of the content of the optically active compound having no polymerizable group with respect to the total mass of the solid content of the composition is preferably 0.2% by mass to 20% by mass, more preferably 0.5% by mass to 10% by mass, and particularly preferably 2% by mass to 8% by mass.

The helical pitch, and the selective reflection wavelength and the range thereof which will be described later are adjusted, for example, depending on not only the type of the cholesteric liquid crystal compound but also the content of the optically active compound. For example, in a case where the content of the optically active compound in the liquid crystal layer is doubled, the helical pitch is ½, and the center value of the selective reflection wavelength is also ½.

### (Polymerization Initiator)

The composition preferably contains a polymerization initiator.

The type of the polymerization initiator is not limited. The polymerization initiator may be a known polymerization initiator. The polymerization initiator is preferably a photopolymerization initiator. Examples of the photopolymerization initiator include an α-carbonyl compound (see, for example, U.S. Pat. Nos. 2,367,661A and 2,367,670A), an acyloin ether compound (see, for example, U.S. Pat. No. 2,448,828A), an α-hydrocarbon-substituted aromatic acyloin compound (see, for example, U.S. Pat. No. 2,722,512A), a polynuclear quinone compound (see, for example, U.S. Pat. Nos. 3,046,127A and 2,951,758A), a combination of a triarylimidazole dimer and p-aminophenyl ketone (see, for example, U.S. Pat. No. 3,549,367A), an acridine compound and a phenazine compound (see, for example, JP1985-105667A (JP-S60-105667A) and U.S. Pat. No. 4,239,850A), and an oxadiazole compound (see, for example, U.S. Pat. No. 4,212,970A).

Examples of the photopolymerization initiator include a photoradical polymerization initiator and a photocationic polymerization initiator. Preferred examples of the photoradical polymerization initiator include an α-hydroxyalkylphenone compound, an α-aminoalkylphenone compound, an acylphosphine oxide compound, a thioxanthone compound, and an oxime ester compound. Preferred examples of the photocationic polymerization initiator include an iodonium salt compound and a sulfonium salt compound.

The composition may contain one type of polymerization initiator or two or more types of polymerization initiators.

From the viewpoint of ease of adjusting a helical pitch, polymerization rate, and strength of a liquid crystal layer after curing, the proportion of the content of the polymerization initiator with respect to the total mass of the solid content of the composition is preferably 0.05% by mass to 10% by mass, more preferably 0.05% by mass to 5% by mass, still more preferably 0.1% by mass to 4% by mass, and particularly preferably 0.2% by mass to 3% by mass.

### (Polymerizable Monomer)

The composition may contain a polymerizable monomer. The polymerizable monomer can promote the crosslinking of the cholesteric liquid crystal compound.

Examples of the polymerizable monomer include a monomer or oligomer that has two or more ethylenically unsaturated groups and undergoes addition polymerization upon irradiation with light.

Examples of the polymerizable monomer include a compound having an ethylenically unsaturated group.

Examples of the polymerizable monomer include a monofunctional acrylate, a monofunctional methacrylate, a polyfunctional acrylate, and a polyfunctional methacrylate.

Examples of the polymerizable monomer include polyethylene glycol mono(meth)acrylate, polypropylene glycol mono(meth)acrylate, and phenoxyethyl (meth)acrylate.

Specific examples of the polymerizable monomer include polyethylene glycol di(meth)acrylate, polypropylene glycol di(meth)acrylate, trimethylolethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylol propane tri (acryloy loxypropyl) ether, tri (acryloyloxyethyl) isocyanurate, tri (acryloy loxyethyl) cyanurate, and glycerin tri(meth)acrylate.

Examples of the polymerizable monomer include a compound formed by adding ethylene oxide or propylene oxide to a polyfunctional alcohol such as trimethylolpropane or glycerin, followed by(meth)acrylation.

Examples of the polymerizable monomer include urethane acrylates described in JP1973-41708B (JP-S48-41708B), JP1975-6034B (JP-S50-6034B), and JP1976-37193A (JP-S51-37193A).

In addition, examples of the polymerizable monomer include polyester acrylates described in JP1973-64183A (JP-S48-64183A), JP1974-43191B (JP-S49-43191B), and JP1977-30490B (JP-S52-30490B).

Further, examples of the polymerizable monomer include epoxy acrylates, which are reaction products of an epoxy resin and a (meth)acrylic acid.

Preferred examples of the polymerizable monomer include trimethylolpropane tri(meth)acrylate, pentaerythritol tetra(meth)acrylate, dipentaerythritol hexa(meth)acrylate, and dipentaerythritol penta(meth)acrylate.

In addition, preferred examples of the polymerizable monomer include the “polymerizable compound B” described in JP1999-133600A (JP-H11-133600A).

The polymerizable monomer may be a cationically polymerizable monomer. Examples of the cationically polymerizable monomer include an epoxy compound, a vinyl ether compound, and an oxetane compounds described in JP1994-9714A (JP-H6-9714A), JP2001-31892A, JP2001-40068A, JP2001-55507A, JP2001-310938A, JP2001-310937A, and JP2001-220526A.

Examples of the epoxy compound include an aromatic epoxide, an alicyclic epoxide, and an aliphatic epoxide.

Examples of the aromatic epoxide include a diglycidyl ether or polyglycidyl ether of bisphenol A. a diglycidyl ether or polyglycidyl ether of an alkylene oxide adduct of bisphenol A, a diglycidyl ether or polyglycidyl ether of hydrogenated bisphenol A, a diglycidyl ether or polyglycidyl ether of an alkylene oxide adduct of hydrogenated bisphenol A, and a novolac type epoxy resin. Examples of the alkylene oxide include ethylene oxide and propylene oxide.

Examples of the alicyclic epoxide include a cyclohexene oxide-containing compound or cyclopentene oxide-containing compound which is obtained by epoxidizing a compound having a cycloalkane ring (for example, a cyclohexene ring or a cyclopentene ring) with an oxidizing agent (for example, hydrogen peroxide or peracid).

Examples of the aliphatic epoxide include a diglycidyl ether or polyglycidyl ether of an aliphatic polyhydric alcohol and a diglycidyl ether or polyglycidyl ether of an alkylene oxide adduct of an aliphatic polyhydric alcohol. Examples of the aliphatic epoxide include a diglycidyl ether of alkylene glycol (for example, a diglycidyl ether of ethylene glycol, a diglycidyl ether of propylene glycol, or a diglycidyl ether of 1,6-hexanediol). Examples of the aliphatic epoxide include a polyglycidyl ether of a polyhydric alcohol (for example, a diglycidyl ether or polyglycidyl ether of glycerin or a diglycidyl ether or polyglycidyl ether of an alkylene oxide adduct of glycerin). Examples of the aliphatic epoxide include a diglycidyl ether of a polyalkylene glycol (for example, a diglycidyl ether of polyethylene glycol or a diglycidyl ether of an alkylene oxide adduct of polyethylene glycol or a diglycidyl ether of polypropylene glycol or a diglycidyl ether of an alkylene oxide adduct of polypropylene glycol). Examples of the alkylene oxide include ethylene oxide and propylene oxide.

Examples of the cationically polymerizable monomer include a monofunctional or difunctional oxetane monomer. For example, 3-ethyl-3-hydroxymethyloxetane (for example, OXT101 manufactured by Toagosei Co., Ltd.), 1.4-bis[(3-ethyl-3-oxetanyl)methoxymethyl benzene (for example, OXT121 manufactured by Toagosei Co., Ltd.), 3-ethyl-3-(phenoxymethyl)oxetane (for example, OXT211 manufactured by Toagosei Co., Ltd.), di(1-ethyl-3-oxetanyl)methyl ether (for example, OXT221 manufactured by Toagosei Co., Ltd.), and 3-ethyl-3-(2-ethylhexyloxymethyl)oxetane (for example, OXT212 manufactured by Toagosei Co., Ltd.) are preferably used. In particular, 3-ethyl-3-hydroxymethyloxetane, 3-ethyl-3-(phenoxymethyl)oxetane, and di(1-ethyl-3-oxetanyl)methyl ether are preferable. The monofunctional or polyfunctional oxetane compounds described in JP2001-220526A and JP2001-310937A may be used.

### (Polyfunctional Polymerizable Compound)

The composition may contain a polyfunctional polymerizable compound. The poly functional polymerizable compound can contribute to suppression of changes in reflectivity after molding.

Examples of the polyfunctional polymerizable compound include a cholesteric liquid crystal compound having two or more ethylenically unsaturated groups and not having a cyclic ether group, a cholesteric liquid crystal compound having two or more cyclic ether groups and not having an ethylenically unsaturated group, a cholesteric liquid crystal compound having two or more ethylenically unsaturated groups and two or more cyclic ether groups, an optically active compound having two or more polymerizable groups, and a crosslinking agent.

Preferred examples of the ethylenically unsaturated group include a (meth)acryloyl group. More preferred examples of the ethylenically unsaturated group include a (meth)acryloxy group.

Preferred examples of the cyclic ether group include an epoxy group and an oxetanyl group. More preferred examples of the cyclic ether group include an oxetanyl group.

The polyfunctional polymerizable compound preferably includes at least one compound selected from the group consisting of a cholesteric liquid crystal compound having two or more ethylenically unsaturated groups and not having a cyclic ether group, a cholesteric liquid crystal compound having two or more cyclic ether groups and not having an ethylenically unsaturated group, and an optically active compound having two or more polymerizable groups, and more preferably includes an optically active compound having two or more polymerizable groups.

The composition may contain one type of polyfunctional polymerizable compound or two or more types of polyfunctional polymerizable compounds.

From the viewpoint of bending resistance, the proportion of the content of the polyfunctional polymerizable compound with respect to the total mass of the solid content of the composition is preferably 0.5% by mass to 70% by mass, more preferably 1% by mass to 50% by mass, still more preferably 1.5% by mass to 20% by mass, and particularly preferably 2% by mass to 10% by mass.

### (Photoisomerization Compound)

The composition may contain a photoisomerization compound.

The type of the photoisomerization compound is not limited. The photoisomerization compound may be a known photoisomerization compound. From the viewpoint of suppressing changes in reflectivity after molding and maintenance of an isomerization structure, a compound in which a steric structure changes by exposure is preferable.

The photoisomerization compound has a photoisomerization structure. From the viewpoint of suppressing changes in reflectivity after molding, ease of photoisomerization, and maintenance of an isomerization structure, the photoisomerization compound preferably has a structure in which a steric structure changes by exposure, more preferably has a di- or higher substituted ethylenically unsaturated bond in which an EZ configuration is isomerized by exposure, and particularly preferably has a di-substituted ethylenically unsaturated bond in which an EZ configuration is isomerized by exposure. The isomerization of the EZ configuration includes cis-trans isomerization. The di-substituted ethylenically unsaturated bond is preferably an ethylenically unsaturated bond substituted with an aromatic group and an ester bond.

From the viewpoint of suppressing changes in reflectivity after molding, ease of photoisomerization, and maintenance of an isomerization structure, it is preferable that the photoisomerization compound has two or more photoisomerization structures. The number of photoisomerization structures in the photoisomerization compound is preferably 2 to 4 and more preferably 2.

The photoisomerization compound is preferably a photoisomerization compound that also acts as the above-mentioned optically active compound. The photoisomerization compound that also acts as an optically active compound is preferably an optically active compound having a molar absorption coefficient of 30,000 or more at a wavelength of 313 nm.

Examples of the photoisomerization compound that also acts as an optically active compound (also referred to as a chiral agent) include a compound represented by Formula (CH1). The compound represented by Formula (CH1) can change an alignment structure such as a helical pitch (twisting force and helical twisting angle) depending on an amount of light at the time of irradiation with light. In addition, the compound represented by Formula (CH1) is a compound in which the EZ configuration in two ethylenically unsaturated bonds can be isomerized by exposure.

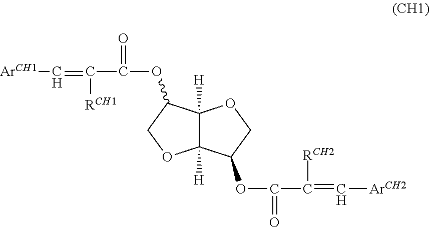

In Formula (CH1), Ar^{CH1} and Ar^{CH2} each independently represent an aryl group or a heteroaromatic ring group, and R^{CH1} and R^{CH2} each independently represent a hydrogen atom or a cyano group.

In Formula (CH1), it is preferable that Ar^{CH1} and Ar^{CH2} are each independently an aryl group. The aryl group may have a substituent. The substituent is preferably, for example, a halogen atom, an alkyl group, an alkenyl group, an alkynyl group, an alkoxy group, a hydroxy group, an acyl group, an alkoxycarbonyl group, an aryloxycarbonyl group, an acyloxy group, a carboxy group, a cyano group, or a heterocyclic group, and more preferably a halogen atom, an alkyl group, an alkenyl group, an alkoxy group, a hydroxy group, an acyloxy group, an alkoxycarbonyl group, or an aryloxycarbonyl group. The total number of carbon atoms in the aryl group is preferably 6 to 40 and more preferably 6 to 30.

It is preferable that Ar^{CH1} and Ar^{CH2} are each independently an aryl group represented by Formula (CH2) or Formula (CH3).

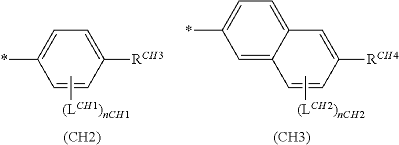

In Formula (CH2) and Formula (CH3), R^{CH3} and R^{CH4} each independently represent a hydrogen atom, a halogen atom, an alkyl group, an alkenyl group, an alkynyl group, an aryl group, a heterocyclic group, an alkoxy group, a hydroxy group, an acyl group, an alkoxycarbonyl group, an aryloxycarbonyl group, an acyloxy group, a carboxy group, or a cyano group, L^{CH1} and L^{CH2} each independently represent a halogen atom, an alkyl group, an alkoxy group, or a hydroxy group, nCH1 represents an integer of 0 to 4, nCH2 represents an integer of 0 to 6, and * represents a bonding position with the ethylenically unsaturated bond in Formula (CH1).

In Formula (CH2) and Formula (CH3), R^{CH3} and R^{CH4} are each independently preferably a hydrogen atom, a halogen atom, an alkyl group, an alkenyl group, an aryl group, an alkoxy group, a hydroxy group, an alkoxycarbonyl group, an aryloxycarbonyl group, or an acyloxy group, more preferably an alkoxy group, a hydroxy group, or an acyloxy group, and particularly preferably an alkoxy group.

In Formula (CH2) and Formula (CH3), L^{CH1} and L^{CH2} are each independently preferably an alkoxy group having 1 to 10 carbon atoms, or a hydroxy group.

nCH1 in Formula (CH2) is preferably 0 or 1.

nCH2 in Formula (CH3) is preferably 0 or 1.

The heteroaromatic ring group in Ar^{CH1} and Ar^{CH2} in Formula (CH1) may have a substituent. The substituent is preferably, for example, a halogen atom, an alkyl group, an alkenyl group, an alkynyl group, an aryl group, an alkoxy group, a hydroxy group, an acyl group, an alkoxycarbonyl group, an aryloxycarbonyl group, an acyloxy group, or a cyano group, and more preferably a halogen atom, an alkyl group, an alkenyl group, an aryl group, an alkoxy group, or an acyloxy group. The total number of carbon atoms in the heteroaromatic ring group is preferably 4 to 40 and more preferably 4 to 30. The heteroaromatic ring group is preferably a pyridyl group, a pyrimidinyl group, a furyl group, or a benzofuranyl group, and more preferably a pyridyl group or a pyrimidinyl group.

In Formula (CH1), it is preferable that R^{CH1} and R^{CH2} are each independently a hydrogen atom.

Preferred specific examples of the photoisomerization compound are shown below. In the following specific examples, Bu represents an n-butyl group. In the following compounds, the steric configuration of each ethylenically unsaturated bond is an E-form (trans-form), which changes to Z-form (cis-form) by exposure.

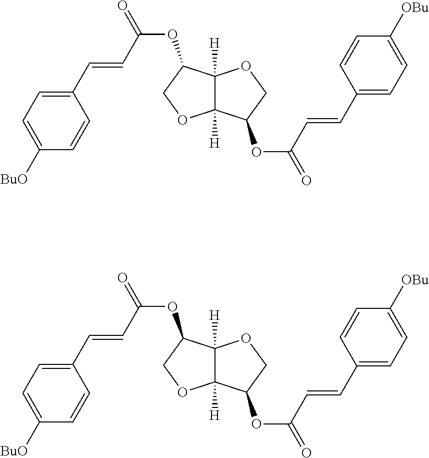

The composition may contain one type of photoisomerization compound or two or more types of photoisomerization compounds.

From the viewpoint of bending resistance, the proportion of the content of the photoisomerization compound with respect to the total mass of the solid content of the composition is preferably 1% by mass to 20% by mass, more preferably 2% by mass to 10% by mass, still more preferably 3% by mass to 9% by mass, and particularly preferably 4% by mass to 8% by mass.

### (Crosslinking Agent)

The composition may contain a crosslinking agent. The crosslinking agent can improve the strength and durability of the liquid crystal layer after curing.

The type of the crosslinking agent is not limited. The crosslinking agent may be a known crosslinking agent. The crosslinking agent is preferably a compound which is cured by ultraviolet rays, heat, or moisture.

Examples of the crosslinking agent include polyfunctional acrylate compounds such as trimethylolpropane tri(meth)acrylate and pentaerythritol tri(meth)acrylate; epoxy compounds such as glycidyl (meth)acrylate, ethylene glycol diglycidyl ether, and 3′,4′-epoxycyclohexylmethyl 3,4-epoxycyclohexanecarboxylate; oxetane compounds such as 2-ethylhexyloxetane and xylylenebisoxetane; aziridine compounds such as 2,2-bishydroxymethylbutanol-tris[3-(1-aziridinyl) propionate] and 4,4-bis(ethyleneiminocarbonylamino)diphenylmethane; isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a known catalyst may be used depending on the reactivity of the crosslinking agent. The use of the catalyst can improve productivity in addition to improving the strength and durability of the liquid crystal layer.

The composition may contain one type of crosslinking agent or two or more types of crosslinking agents.

From the viewpoint of strength and durability of the liquid crystal layer, the proportion of the content of the crosslinking agent with respect to the total mass of the solid content of the composition is preferably 1% by mass to 20% by mass, and more preferably 3% by mass to 15% by mass.

### (Solvent)

The composition may contain a solvent.

Examples of the solvent include an organic solvent. Examples of the organic solvent include a ketone compound (for example, methyl ethyl ketone and methyl isobutyl ketone), an alkyl halide compound, an amide compound, a sulfoxide compound, a heterocyclic compound, a hydrocarbon compound, an ester compound, an ether compound, and an alcohol compound. A ketone compound is preferable in consideration of the burden on the environment.

Examples of the solvent include a high boiling point solvent. In a case where the composition contains a high boiling point solvent, the viscosity of the liquid crystal during drying decreases, and the aligning properties of the liquid crystal are improved. The boiling point of the high boiling point solvent is preferably 150° C. or higher and more preferably 160° C. or higher. Examples of the high boiling point solvent include furfuryl alcohol, 2-thiophenemethanol, benzyl alcohol, tetrahydrofurfuryl alcohol, γ-butyrolactone, N-methyl-2-pyrrolidone, ethyl acetoacetate, methyl benzoate, ethyl benzoate, and methyl o-toluate.

The composition may contain one type of solvent or two or more types of solvents.

The proportion of the content of the solvent with respect to the total mass of the composition is preferably 50% by mass to 85% by mass, more preferably 60% by mass to 80% by mass, and still more preferably 65% by mass to 75% by mass. From the viewpoint of the aligning properties of the liquid crystal, the proportion of the content of the high boiling point solvent with respect to the content of the solvent is preferably 2% by mass to 30% by mass, more preferably 4% by mass to 25% by mass, and still more preferably 6% by mass to 20% by mass.

### (Other Additives)

The composition may contain other additives. Examples of the other additives include a surfactant, a polymerization inhibitor, an antioxidant, a horizontal alignment agent, an ultraviolet absorber, a light stabilizer, a colorant, and metal oxide particles.

### [Second Cured Liquid Crystal Layer]

The laminate may have one or two or more cured liquid crystal layers, and from the viewpoint of lustrousness, it is preferable that the laminate further has a second cured liquid crystal layer other than the first cured liquid crystal layer. The cured liquid crystal layer other than the first cured liquid crystal layer may be two or more cured liquid crystal layers as in a case where a second cured liquid crystal layer is provided, or a case where a second cured liquid crystal layer and a third cured liquid crystal layer are provided.

In the present disclosure, the first cured liquid crystal layer, the second cured liquid crystal layer, and the like are also collectively and simply referred to as a “cured liquid crystal layer”.

In a case where the laminate has two or more cured liquid crystal layers, one cured liquid crystal layer (for example, a first cured liquid crystal layer) may be in direct contact with the other cured liquid crystal layer (for example, a second cured liquid crystal layer), and it is preferable that the one cured liquid crystal layer is in direct contact with the other cured liquid crystal layer. In a case where the laminate has two or more cured liquid crystal layers, one cured liquid crystal layer (for example, a first cured liquid crystal layer) may be in contact with the other cured liquid crystal layer (for example, a second cured liquid crystal layer) through another layer (for example, an adhesive layer). In a case where the laminate has two or more cured liquid crystal layers, the tint of one cured liquid crystal layer (for example, a first cured liquid crystal layer) may be the same as or different from the tint of the other cured liquid crystal layer (for example, a second cured liquid crystal layer). In a case where the tint of one cured liquid crystal layer is different from the tint of the other cured liquid crystal layer, the designability is improved by additive color mixing. The compositions of the two or more cured liquid crystal layers may be the same as or different from each other. The laminate may be a laminate of layers in which all of the cholesteric liquid crystal compounds are rod-like cholesteric liquid crystal compounds, a laminate of a layer containing a disk-like cholesteric liquid crystal compound and a layer containing a rod-like cholesteric liquid crystal compound, or a laminate of layers in which all of the cholesteric liquid crystal compounds are disk-like cholesteric liquid crystal compounds.

In a case where the laminate has two or more cured liquid crystal layers, a combination of the alignment states of the cured liquid crystal layers is also not limited. Cured liquid crystal layers having the same alignment state may be laminated. Cured liquid crystal layers having different alignment states may be laminated. Above all, from the viewpoint of improving lustrousness and reflectivity, the laminate preferably has a first cured liquid crystal layer having a helical structure and a second cured liquid crystal layer having a helical structure in the opposite direction to the helical structure of the first cured liquid crystal layer. The “helical structure” means a helical structure of a cholesteric liquid crystal.

From the viewpoint of bending resistance, the thickness of the cured liquid crystal layer is preferably less than 10 μm, more preferably 5 μm or less, still more preferably 0.05 μm to 5 μm, and particularly preferably 0.1 μm to 5 μm.

In a case where the laminate includes two or more cured liquid crystal layers, it is preferable that the two or more cured liquid crystal layers are each independently adjusted to have a thickness within the above-described range.

The color of the cured liquid crystal layer and a change in color depending on the viewing angle are adjusted by, for example, at least one selected from the group consisting of a helical pitch, a refractive index, and a thickness. The helical pitch is adjusted, for example, by the addition amount of the optically active compound (chiral agent). The details thereof are described in, for example, “FUJIFILM research & development No. 50 (2005), pp. 60 to 63”. The helical pitch may be adjusted by conditions such as a temperature, an illuminance, and an irradiation time in a case of fixing the cholesteric alignment state.

### [Alignment Layer]

The laminate may have an alignment layer at a position adjacent to the cured liquid crystal layer. The alignment layer can align the molecules of the cholesteric liquid crystal compound in a manufacturing process of the cured liquid crystal layer.

The alignment layer is provided by, for example, a method such as a rubbing treatment of an organic compound (preferably a polymer), oblique vapor deposition of an inorganic compound such as SiO, or formation of a layer having microgrooves. An alignment layer in which an alignment function is generated by application of an electric field, application of a magnetic field, or irradiation with light is also known as the alignment layer.

Examples of the alignment layer include a rubbing-treated alignment layer and a photoalignment layer. The rubbing-treated alignment layer is formed, for example, by a rubbing treatment. The photoalignment layer is formed, for example, by irradiation with light.

Examples of the polymer used in the rubbing-treated alignment layer include a methacrylate-based copolymer, a styrene-based copolymer, a polyolefin, a polyvinyl alcohol, a modified polyvinyl alcohol, a poly(N-methylolacrylamide), a polyester, a polyimide, a vinyl acetate copolymer, a carboxymethyl cellulose, and a polycarbonate, which are described in paragraph of JP1996-338913A (JP-H8-338913A). Examples of the polymer used in the rubbing-treated alignment layer include a silane coupling agent. The polymer used in the rubbing-treated alignment layer is preferably, for example, a water-soluble polymer (for example, a poly(N-methylolacrylamide), a carboxymethyl cellulose, a gelatin, a polyvinyl alcohol, or a modified polyvinyl alcohol), more preferably a gelatin, a polyvinyl alcohol, or a modified polyvinyl alcohol, and particularly preferably a polyvinyl alcohol or a modified polyvinyl alcohol.

The rubbing treatment is carried out, for example, by rubbing a surface of a film containing a polymer as a main component with paper or cloth in a certain direction. The general method of the rubbing treatment is described in, for example, “Handbook of Liquid Crystals” (published by Maruzen Co., Ltd., Oct. 30, 2000).

Examples of a method of changing a rubbing density include the method described in “Handbook of Liquid Crystals” (published by Maruzen Co., Ltd.). The rubbing density (L) is quantified by Expression (A).

$$L = N 1 ( 1 + 2 π rn / 60 v ) \qquad Expression ( A )$$

In Expression (A), N represents the number of times of rubbing, 1 represents a contact length of a rubbing roller, r represents a radius of the roller, n represents a rotation speed (revolutions per minute (rpm)) of the roller, and v represents a stage moving speed (speed per second).

Examples of a method of increasing the rubbing density include a method of increasing the number of times of rubbing, a method of increasing a contact length of a rubbing roller, a method of increasing a radius of a roller, a method of increasing a rotation speed of a roller, and a method of decreasing a stage moving speed. The opposite conditions of the above-described methods allow the rubbing density to be reduced.

For the conditions of the rubbing treatment, the description in JP4052558B may be referred to.

Examples of a photo-alignment material used for the photoalignment layer include the azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B: the aromatic ester compounds described in JP2002-229039A: the maleimide and/or alkenyl-substituted nadiimide compounds having a photo alignment unit described in JP2002-265541A and JP2002-317013A: the photo-crosslinkable silane derivatives described in JP4205195B and JP4205198B; and the photo-crosslinkable polyimides, polyamides, or esters described in JP2003-520878A, JP2004-529220A, and JP4162850B. An azo compound, a photo-crosslinkable polyimide, a polyamide, or an ester is preferable.

The photoalignment layer is formed, for example, by subjecting a layer formed of the above-described material to irradiation with linearly polarized light or non-polarized light. The “irradiation with linearly polarized light” is an operation for causing a photoreaction in the photo-alignment material.

The light used for irradiation with light is preferably light having a peak wavelength of 200 nm to 700 nm, and more preferably ultraviolet light having a peak wavelength of 400 nm or less.

Examples of a light source used for irradiation with light include lamps (for example, a tungsten lamp, a halogen lamp, a xenon lamp, a xenon flash lamp, a mercury lamp, a mercury xenon lamp, and a carbon arc lamp), lasers (for example, a semiconductor laser, a helium neon laser, an argon ion laser, a helium cadmium laser, and a YAG laser), light emitting diodes, and cathode ray tubes.

Examples of a method for obtaining linearly polarized light include a method of using a polarizing plate (for example, an iodine polarizing plate, a dichroic coloring agent polarizing plate, or a wire grid polarizing plate), a method of using a prism-based element (for example, a Glan-Thompson prism) or a reflective type polarizer using a Brewster's angle, and a method of using light emitted from a laser light source having polarized light. In addition, only light having a required wavelength may be selectively applied using a filter or a wavelength conversion element.

In the irradiation with linearly polarized light, light may be applied perpendicularly or obliquely to the upper surface or lower surface of the alignment layer. An incidence angle of light with respect to the alignment layer is preferably 0° to 90° and more preferably 40° to 90°.

In the irradiation with non-polarized light, non-polarized light is applied obliquely to the upper surface or lower surface of the alignment layer. The incidence angle of light is preferably 10° to 80°, more preferably 20° to 60°, and particularly preferably 30° to 50°.

The irradiation time is preferably 1 minute to 60 minutes and more preferably 1 minute to 10 minutes.

The thickness of the alignment layer is preferably 0.01 μm to 10 μm.

A underlayer other than the alignment layer may be provided at a position adjacent to the cured liquid crystal layer.

Depending on the material constituting the underlayer other than the alignment layer, even in a case where the alignment layer is not provided, the underlayer can also be made to function as the alignment layer by carrying out a direct alignment treatment (for example, a rubbing treatment) on the underlayer. Examples of the underlayer as described above include polyethylene terephthalate (PET).

In a case where two or more cured liquid crystal layers are laminated, the cured liquid crystal layer as an underlayer behaves as an alignment layer, and the cholesteric liquid crystal compound may be aligned in a manufacturing process of the cured liquid crystal layer as an upper layer that is in contact with the cured liquid crystal layer as an underlayer. In the above-described aspect, the cholesteric liquid crystal compound is aligned in a manufacturing process of the cured liquid crystal layer as the upper layer even in a case where an alignment layer is not provided or an alignment treatment (for example, a rubbing treatment) is not carried out.

### [Colored Layer]

The laminate may have a colored layer. Having the colored layer improves the designability.

The position of the colored layer in the laminate is not limited. From the viewpoint of designability: the laminate preferably includes the colored layer, the substrate, the adhesive layer, and the first cured liquid crystal layer in this order. From the viewpoint of designability, moldability, and durability, the laminate preferably includes the substrate, the adhesive layer, the first cured liquid crystal layer, and the colored layer.

The laminate may include two or more colored layers. At least one colored layer in the laminate is preferably a layer that is visible through the first cured liquid crystal layer. It is considered that, in a case where at least one colored layer is a layer that is visible through the first cured liquid crystal layer, a change in color occurs depending on a viewing angle of the colored layer based on the anisotropy depending on the angle of light incident into the first cured liquid crystal layer, resulting in development of special designability. In a case where the laminate includes two or more colored layers, it is preferable that at least one colored layer is a layer that is visible through the first cured liquid crystal layer and at least one of the other colored layers is a layer closer to the observer than the liquid crystal layer (also referred to as a “color filter layer”). The color filter layer may be a layer having high transmittance to light having a specific wavelength. The color filter layer may be a monochromatic color filter layer. The color filter layer may be a color filter layer having a color filter structure of two or more colors and, if necessary; a black matrix or the like. According to the color filter layer, for example, a laminate having excellent designability and being visible in a specific wavelength range can be obtained.

From the viewpoint of visibility, the total light transmittance of at least one colored layer (preferably, a colored layer that is visible through a liquid crystal layer) is preferably 10% or less.

Examples of the color of the colored layer include black, gray; white, red, orange, yellow; green, blue, and violet. The color of the colored layer may be a metallic color.

Examples of the components of the colored layer include a colorant, a resin (for example, a binder polymer), a dispersant, and other additives. The colored layer may contain a polymerizable compound and a polymerization initiator.

The colored layer preferably contains a colorant. Examples of the colorant include a pigment and a dye. From the viewpoint of durability, a pigment is preferable. The metallic colored layer may contain components such as a metal particle and a pearl pigment. In the formation of the metallic colored layer, a method such as vapor deposition or plating may be applied.

Examples of the pigment include an inorganic pigment and an organic pigment.

Examples of the inorganic pigment include a white pigment (for example, titanium dioxide, zinc oxide, lithopone, light calcium carbonate, white carbon, aluminum oxide, aluminum hydroxide, or barium sulfate), a black pigment (for example, carbon black, titanium black, titanium carbon, iron oxide, or graphite), iron oxide, barium yellow; cadmium red, and chrome yellow. For example, the inorganic pigments described in paragraph and paragraph of JP2005-7765A may be applied as the inorganic pigment.

Examples of the organic pigment include a phthalocyanine-based pigment such as phthalocyanine blue or phthalocyanine green, an azo-based pigment such as azo red, azo yellow; or azo orange, a quinacridone-based pigment such as quinacridone red, cinquasia red, or cinquasia magenta, a perylene-based pigment such as perylene red or perylene maroon, carbazole violet, anthrapyridine, flavanthrone yellow; isoindoline yellow; indanthrone blue, dibromoanthanthrone red, anthraquinone red, and diketopyrrolopyrrole. Specific examples of the organic pigment include a red pigment such as C. I. Pigment Red 177, 179, 224, 242, 254, 255, or 264: a yellow pigment such as C. I. Pigment Yellow 138, 139, 150, 180, or 185: an orange pigment such as C. I. Pigment Orange 36, 38, or 71: a green pigment such as C. I. Pigment Green 7, 36, or 58: a blue pigment such as C. I. Pigment Blue 15:6; and a violet pigment such as C. I. Pigment Violet 23. The organic pigments described in paragraph of JP2009-256572A may be applied as the organic pigment.

The pigment may be a pigment having light transmittance and light reflectivity (so-called bright pigment). Examples of the bright pigment include a metallic bright pigment such as aluminum, copper, zinc, iron, nickel, tin, aluminum oxide, or an alloy thereof, an interference mica pigment, a white mica pigment, a graphite pigment, and a glass flake pigment. The bright pigment may be a non-colored bright pigment. The bright pigment may be a colored bright pigment. In a case where exposure is carried out in the molding of the laminate, it is preferable that the bright pigment is used in a range where the curing by the exposure is not hindered.

The colored layer may contain one type of colorant or two or more types of colorants. A combination of an inorganic pigment and an organic pigment may be applied.

From the viewpoint of desired color expression and molding suitability; the proportion of the content of the colorant to the total mass of the colored layer is preferably 1% by mass to 50% by mass, more preferably 5% by mass to 50% by mass, and particularly preferably 10% by mass to 40% by mass.

From the viewpoint of molding suitability, strength, and scratch resistance, the colored layer preferably further contains a binder polymer. The binder polymer is preferably a transparent resin. A resin having a total light transmittance of 80% or more is preferable. The total light transmittance is measured with a spectrophotometer (for example, spectrophotometer UV-2100 manufactured by Shimadzu Corporation).

Examples of the binder polymer include an acrylic resin, a silicone resin, a polyester, a polyurethane, and a polyolefin. The binder polymer may be a homopolymer or a copolymer.

The colored layer may contain one type of binder polymer or two or more types of binder polymers.

From the viewpoint of moldability, the proportion of the content of the binder polymer with respect to the total mass of the colored layer is preferably 5% by mass to 70% by mass, more preferably 10% by mass to 60% by mass, and particularly preferably 20% by mass to 60% by mass.

The colored layer may further contain a dispersant. The dispersant can improve dispersibility of the colorant (particularly, the pigment) in the colored layer to improve the uniformity of color.

The dispersant is preferably a polymer dispersant. Examples of the polymer dispersant include a silicone polymer, an acrylic polymer, and a polyester polymer. From the viewpoint of heat resistance, the dispersant is preferably a silicone polymer such as a grafted silicone polymer.

A weight-average molecular weight of the dispersant is preferably 1,000 to 5,000,000, more preferably 2,000 to 3,000,000, and particularly preferably 2,500 to 3,000,000. In a case where the weight-average molecular weight is 1,000 or more, dispersibility of the colorant is further improved.

The dispersant may be a commercially available product. Examples of the commercially available product of the dispersant include EFKA 4300 (acrylic polymer dispersant) available from BASF Japan Ltd., HOMOGENOL L-18, HOMOGENOL L-95, and HOMOGENOL L-100 available from Kao Corporation, SOLSPERSE 20000 and SOLSPERSE 24000 available from Lubrizol Japan Limited, and DISPERBYK-110, DISPERBYK-164, DISPERBYK-180, and DISPERBYK-182 available from BYK-Chemie Japan KK. “HOMOGENOL”, “SOLSPERSE”, and “DISPERBYK” are all registered trademarks.

The colored layer may contain one type of dispersant or two or more types of dispersants.

The content of the dispersant with respect to 100 parts by mass of the colorant is preferably 1 part by mass to 30 parts by mass.

The colored layer may further contain other additives. Examples of the additives include the surfactants described in paragraph of JP4502784B and paragraphs [0060] to [0071] of JP2009-237362A, the thermal polymerization inhibitors described in paragraph [0018] of JP4502784B (also referred to as a polymerization inhibitor, preferred examples of which include phenothiazine), and the additives described in paragraphs [0058] to [0071] of JP2000-310706A.

From the viewpoint of visibility and three-dimensional moldability; the thickness of the colored layer is preferably 0.5 μm or more, more preferably 3 μm or more, still more preferably 3 μm to 50 μm, and particularly preferably 3 μm to 20 μm. In a case where the laminate includes two or more colored layers, it is preferable that the two or more colored layers are each independently adjusted to have a thickness within the above-described range.

Examples of a method for forming the colored layer include a method of using a composition for forming a colored layer, and a method of bonding colored films to each other. The method for forming the colored layer is preferably a method of using a composition for forming a colored layer. The colored layer may be formed using a commercially available paint such as NAX REAL series, NAX ADMILA series, or NAX MULTI series (Nippon Paint Co., Ltd.) or RETAN PG series (Kansai Paint Co., Ltd.).

Examples of the method of using the composition for forming a colored layer include a method of applying the composition for forming a colored layer to form a colored layer and a method of printing the composition for forming a colored layer to form a colored layer. Examples of the printing method include screen printing, ink jet printing, flexographic printing, gravure printing, and offset printing.

Examples of the components of the composition for forming a colored layer include the components of the colored layer described above. The content of each component in the composition for forming a colored layer is adjusted, for example, in a range where “the total mass of the colored layer” described in the description relating to the content of each component in the colored layer described above is read as “the total mass of the solid content of the composition for forming a colored layer”.

It is preferable that the composition for forming a colored layer further contains an organic solvent. Examples of the organic solvent include an alcohol compound, an ester compound, an ether compound, a ketone compound, and an aromatic hydrocarbon compound.

The composition for forming a colored layer may contain one type of organic solvent or two or more types of organic solvents.

A proportion of the content of the organic solvent with respect to the total mass of the composition for forming a colored layer is preferably 5% by mass to 90% by mass and more preferably 30% by mass to 70% by mass.

Examples of a method of preparing the composition for forming a colored layer include a method of mixing an organic solvent and a component to be introduced into the colored layer, such as a colorant. In a case where the composition for forming a colored layer contains a pigment as a colorant, from the viewpoint of further enhancing the uniform dispersibility and dispersion stability of the pigment, a method of preparing the composition for forming a colored layer using a pigment dispersion liquid containing a pigment and a dispersant is preferable.

### [Ultraviolet Absorbing Layer]

The laminate may have an ultraviolet absorbing layer. The ultraviolet absorbing layer can improve light resistance.

A position of the ultraviolet absorbing layer is not limited. The ultraviolet absorbing layer is preferably located at a position closer to the observer than the first cured liquid crystal layer. That is, it is preferable that the ultraviolet absorbing layer is provided on the viewing side with respect to the first cured liquid crystal layer. In other words, it is preferable that the ultraviolet absorbing layer is disposed such that the first cured liquid crystal layer is visible through the ultraviolet absorbing layer.

The ultraviolet absorbing layer is preferably a layer containing an ultraviolet absorber, and more preferably a layer containing an ultraviolet absorber and a binder polymer.

The ultraviolet absorber may be an organic compound or an inorganic compound. Examples of the ultraviolet absorber include a triazine compound, a benzotriazole compound, a benzophenone compound, a salicylic acid compound, and a metal oxide particle. The ultraviolet absorber may be a polymer containing an ultraviolet absorbing structure. Examples of the polymer including an ultraviolet absorbing structure include an acrylic resin containing a monomer unit derived from an acrylic acid ester compound containing at least a part of a compound such as a triazine compound, a benzotriazole compound, a benzophenone compound, or a salicylic acid compound. Examples of the metal oxide particles include titanium oxide particles, zinc oxide particles, and cerium oxide particles.

Examples of the binder polymer include a polyolefin, an acrylic resin, a polyester, a fluororesin, a siloxane resin, and a polyurethane.

The ultraviolet absorbing layer is formed of, for example, a composition for forming an ultraviolet absorbing layer. The ultraviolet absorbing layer may be formed by applying a composition for forming an ultraviolet absorbing layer and, if necessary; drying the applied composition. The composition for forming an ultraviolet absorbing layer contains the components of the ultraviolet absorbing layer described above and, if necessary, a solvent.

From the viewpoint of light resistance and three-dimensional moldability, a thickness of the ultraviolet absorbing layer is preferably 0.01 μm to 100 μm, more preferably 0.1 μm to 50 μm, and particularly preferably 0.5 μm to 20 μm.

### [Protective Layer]

The laminate may have a protective layer.

The protective layer preferably has sufficient strength to protect a layer such as the first cured liquid crystal layer and has excellent weather fastness. Examples of the weather fastness include durability against environmental factors such as ultraviolet rays and moist heat. From the viewpoint of suppressing visibility and reflected glare of light (for example, reflected glare of a fluorescent lamp), the protective layer may have an antireflection ability.

From the viewpoint of strength and weather fastness, the protective layer preferably contains a resin, more preferably contains at least one resin selected from the group consisting of a siloxane resin, a fluororesin, an acrylic resin, a melamine resin, a polyolefin, a polyester, a polycarbonate, and a urethane resin, and still more preferably contains at least one resin selected from the group consisting of a siloxane resin, a fluororesin, an acrylic resin, and a urethane resin, which have voids. In a case where the protective layer contains a siloxane resin or a fluororesin, the refractive index of the protective layer is likely to be 1.5 or less (preferably 1.4 or less), and a protective layer having an excellent antireflection ability can be easily obtained. In a case where the protective layer contains low refractive index particles, the same antireflection effect can be obtained even in a case where the refractive index of the protective layer is reduced to 1.5 or less.

The siloxane resin is obtained, for example, by hydrolytic condensation of a siloxane compound. The siloxane compound is preferably at least one compound selected from the group consisting of a siloxane compound represented by Formula 1 and a hydrolytic condensate of the siloxane compound represented by Formula 1 (hereinafter, also referred to as a specific siloxane compound).

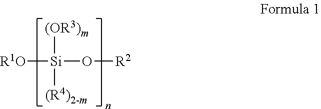

In Formula 1, R¹, R², and R³ each independently represent an alkyl group or alkenyl group having 1 to 6 carbon atoms: in a case of a plurality of R⁴'s, the plurality of R⁴'s each independently represent an alkyl group, a vinyl group, or an alkyl group having a group selected from the group consisting of a vinyl group, an epoxy group, a vinylphenyl group, a (meth)acryloxy group, a (meth)acrylamide group, an amino group, an isocyanurate group, a ureido group, a mercapto group, a sulfide group, a polyoxyalkyl group, a carboxy group, and a quaternary ammonium group: m represents an integer of 0 to 2; and n represents an integer of 1 to 20.

The hydrolytic condensate of the siloxane compound represented by Formula 1 refers to a compound obtained by condensing the siloxane compound represented by Formula 1, and a compound in which at least a part of substituents on the silicon atom in the siloxane compound represented by Formula 1 is hydrolyzed to form a silanol group.

The alkyl group or alkenyl group having 1 to 6 carbon atoms in R¹, R², and R³ in Formula 1 may be linear, may be branched, or may have a ring structure. From the viewpoint of strength, light transmittance, and haze of the protective layer, the alkyl group or alkenyl group having 1 to 6 carbon atoms is preferably an alkyl group. Examples of the alkyl group having 1 to 6 carbon atoms include a methyl group, an ethyl group, a propyl group, an isopropyl group, an n-butyl group, a tert-butyl group, an n-pentyl group, an n-hexyl group, and a cyclohexyl group, among which a methyl group or an ethyl group is preferable and a methyl group is more preferable.

In a case where a plurality of R⁴'s in Formula 1 are present, from the viewpoint of strength, light transmittance, and haze of the protective layer, it is preferable that the plurality of R⁴'s are each independently an alkyl group, and it is more preferable that the plurality of R⁴'s are each independently an alkyl group having 1 to 8 carbon atoms.

The number of carbon atoms of R⁴ in Formula 1 is preferably 1 to 40, more preferably 1 to 20, and particularly preferably 1 to 8.

From the viewpoint of strength, light transmittance, and haze of the protective layer, m in Formula 1 is preferably 1 or 2 and more preferably 2.

From the viewpoint of strength, light transmittance, and haze of the protective layer, n in Formula 1 is preferably an integer of 2 to 20.

Examples of the specific siloxane compound include KBE-04, KBE-13, KBE-22, KBE-1003, KBM-303, KBE-403, KBM-1403, KBE-503, KBM-5103, KBE-903, KBE-9103P, KBE-585, KBE-803, KBE-846, KR-500, KR-515, KR-516, KR-517, KR-518, X-12-1135, X-12-1126, and X-12-1131 manufactured by Shin-Etsu Chemical Co., Ltd.; Dynasylan 4150 manufactured by Evonik Japan Co., Ltd.: MKC SILICATE MS51, MS56, MS57, and MS56S manufactured by Mitsubishi Chemical Corporation; and ETHYL SILICATE 28, N-PROPYL SILICATE, N-BUTYL SILICATE, and SS-101 manufactured by Colcoat Co., Ltd.

In a case where the composition for forming a protective layer containing a siloxane compound is used as a raw material for the protective layer, the composition for forming a protective layer may contain a condensation catalyst that promotes condensation of the siloxane compound. In a case where the composition for forming a protective layer contains a condensation catalyst, a protective layer having more excellent durability is formed. The condensation catalyst may be a known condensation catalyst.

Examples of the fluororesin include the resins described in paragraphs to of JP2009-217258A and paragraphs to of JP2007-229999A.

Examples of the fluororesin include a fluorinated alkyl resin.

Specific examples fluororesin include polytetrafluoroethylene, polychlorotrifluoroethylene, polyvinylidene fluoride, polyvinyl fluoride, perfluoroalkoxyalkane, perfluoroethylene propene, and ethylene tetrafluoroethylene.

Examples of a supply source of the fluororesin include a fluororesin dispersion that is obtained by copolymerizing a fluororesin with an emulsifier or a component enhancing an affinity with water, and then dispersing the resulting copolymer in water.

Examples of a raw material for the fluororesin include a compound having at least one group of a polymerizable functional group or a crosslinkable functional group and containing a fluorine atom. Examples of the raw material for the fluororesin include radically polymerizable monomers such as a perfluoroalkyl (meth)acrylate, a vinyl fluoride monomer, and a vinylidene fluoride monomer. Examples of the raw material for the fluororesin include a cationically polymerizable monomer such as perfluorooxetane.

Examples of commercially available products of the fluororesin or the raw material for the fluororesin include LUMIFLON and OBBLIGATO manufactured by AGC Inc., ZEFFLE and NEOFLON manufactured by Daikin Industries, Ltd., TEFLON® manufactured by DuPont de Nemours, Inc., KYNAR manufactured by Arkema S.A., LINC3A manufactured by Kyoeisha Chemical Co., Ltd., OPTOOL manufactured by Daikin Industries, Ltd., OPSTAR manufactured by Arakawa Chemical Industries, Ltd., and tetrafluorooxetane manufactured by Daikin Industries, Ltd.

Examples of the low refractive index particles (preferably, particles having a refractive index of 1.45 or less) include the particles described in paragraphs to of JP2009-217258A.

Examples of the low refractive index particles include hollow particles formed of inorganic oxide particles such as silica, hollow particles formed of resin particles such as acrylic resin particles, porous particles having a porous structure on a surface thereof, and fluoride particles having a low refractive index of a material itself. Examples of commercially available products of the hollow particles include SLURIA manufactured by JGC C&C, SILINAX manufactured by Nittetsu Mining Co., Ltd., and TECHPOLYMER MBX, SBX, and NH manufactured by Sekisui Kasei Co., Ltd. Examples of commercially available products of the porous particles include LIGHTSTAR manufactured by Nissan Chemical Corporation. Examples of commercially available products of the fluoride particles include magnesium fluoride nanoparticles manufactured by RMML Co., Ltd. Core-shell particles may be used to form closed voids in a matrix containing a resin. As a method for forming a protective layer by applying a composition containing hollow particles, for example, the method described in paragraphs [0028] and [0029] of JP2009-103808A, the method described in paragraphs [0030] and [0031] of JP2008-262187A, or the method described in paragraph [0018] of JP2017-500384A may be applied.

The urethane resin is obtained, for example, by a reaction between a diisocyanate compound and a polyol or a polymerization reaction of a urethane (meth)acrylate compound.

Examples of the diisocyanate compound include an aromatic diisocyanate (for example, 4,4′-diphenylmethane diisocyanate, 2,4-tolylene diisocyanate, 2,6-tolylene diisocyanate, 1,5-naphthalene diisocyanate, p- or m-phenylene diisocyanate, xylylene diisocyanate, or m-tetramethylxylylene diisocyanate). Examples of the diisocyanate compound include an alicyclic diisocyanate (for example, isophorone diisocyanate, 4,4′-dicyclohexylmethane diisocyanate. 1,4-cyclohexylene diisocyanate, or hydrogenated tolylene diisocyanate). Examples of the diisocyanate compound include an aliphatic diisocyanate (for example, hexamethylene diisocyanate). From the viewpoint of resistance to fading, an alicyclic diisocyanate is preferable. One type of diisocyanate compound or two or more types of diisocyanate compounds may be used.

Examples of the polyol include a polyester polyol, a polyether polyol, a polycarbonate polyol, and a polyacrylic polyol. From the viewpoint of impact resistance, a polyester polyol or a polyacrylic polyol is preferable.

The polyester polyol is obtained, for example, by a known method using an esterification reaction in which a polybasic acid and a polyhydric alcohol are used.

Examples of the polybasic acid include a polycarboxylic acid. If necessary, a monobasic fatty acid may also be used in combination. Examples of the polycarboxylic acid include an aromatic polycarboxylic acid (for example, phthalic acid, isophthalic acid, terephthalic acid, tetrahydrophthalic acid, tetrahydroisophthalic acid, hexahydrophthalic acid, hexahydroterephthalic acid, trimellitic acid, or pyromellitic acid). Examples of the polycarboxylic acid include an aliphatic polycarboxylic acid (for example, adipic acid, sebacic acid, succinic acid, azelaic acid, fumaric acid, maleic acid, or itaconic acid). The polycarboxylic acid may be an anhydride of the compound described above. One type of polybasic acid or two or more types of polybasic acids may be used.

Examples of the polyhydric alcohol include a glycol and a trihydric or higher polyhydric alcohol. Examples of the glycol include ethylene glycol, propylene glycol, diethylene glycol, triethylene glycol, tetraethylene glycol, dipropylene glycol, polyethylene glycol, polypropylene glycol, neopentyl glycol, hexylene glycol, 1,3-butanediol, 1,4-butanediol, 1,5-pentanediol, 1,6-hexanediol, 2-butyl-2-ethyl-1,3-propanediol, methylpropanediol, cyclohexanedimethanol, and 3,3-diethyl-1,5-pentanediol. Examples of the trihydric or higher polyhydric alcohol include glycerol, trimethylolethane, trimethylolpropane, pentaerythritol, and dipentaerythritol. One type of polyhydric alcohol or two or more types of polyhydric alcohols may be used.

Examples of the polyacrylic polyol include a known polyacrylic polyol having a hydroxy group capable of reacting with an isocyanate group. Examples of the monomer of the polyacrylic polyol include a (meth)acrylic acid, a (meth)acrylic acid to which a hydroxy group is added, a (meth)acrylic acid alkyl ester, a (meth)acrylamide and a derivative thereof, a carboxylic acid ester of vinyl alcohol, an unsaturated carboxylic acid, and a hydrocarbon having a chain-like unsaturated alkyl moiety.

The urethane (meth)acrylate compound is obtained, for example, by subjecting a compound having a hydroxy group and a (meth)acryloyl group and a polyisocyanate compound to a urethanization reaction.

Examples of the compound having a hydroxy group and a (meth)acryloyl group include a monofunctional (meth)acrylate having a hydroxy group and a polyfunctional (meth)acrylate having a hydroxy group. Examples of the monofunctional (meth)acrylate having a hydroxy group include 2-hydroxyethyl (meth)acrylate, 3-hydroxypropyl (meth)acrylate, 4-hydroxy-n-butyl (meth)acrylate. 2-hydroxypropyl (meth)acrylate, 2-hydroxy-n-butyl (meth)acrylate, 3-hydroxy-n-butyl (meth)acrylate, 1,4-cyclohexanedimethanol mono(meth)acrylate, N-(2-hydroxyethyl)(meth)acrylamide, glycerin mono(meth)acrylate, polyethylene glycol mono(meth)acrylate, polypropylene glycol mono(meth)acrylate, 2-hydroxy-3-phenoxypropyl (meth)acrylate, 2-(meth)acryloyloxyethyl-2-hydroxyethylphthalate, and a lactone-modified (meth)acrylate having a hydroxy group at a terminal thereof. Examples of the polyfunctional (meth)acrylate having a hydroxy group include trimethylolpropane di(meth)acrylate, isocyanuric acid ethylene oxide (EO)-modified diacrylate, pentaerythritol tri(meth)acrylate, and dipentaerythritol penta(meth)acrylate. From the viewpoint of scratch resistance of the protective layer, pentaerythritol triacrylate or dipentaerythritol pentaacrylate is preferable. One type of compound having a hydroxy group and a (meth)acryloyl group or two or more types of compounds having a hydroxy group and a (meth)acryloyl group may be used.

Examples of the polyisocyanate compound include an aromatic diisocyanate compound such as tolylene diisocyanate, diphenylmethane diisocyanate, m-xylylene diisocyanate, or m-phenylenebis(dimethylmethylene) diisocyanate. Examples of the polyisocyanate compound include an aliphatic or alicyclic diisocyanate compound such as hexamethylene diisocyanate, lysine diisocyanate, 1,3-bis(isocyanatomethyl)cyclohexane. 2-methyl-1,3-diisocyanatocyclohexane. 2-methyl-1,5-diisocyanatocyclohexane, 4,4′-dicyclohexylmethane diisocyanate, or isophorone diisocyanate.

The urethane (meth)acrylate is cured, for example, by irradiation with actinic rays. The actinic ray refers to ionizing radiation such as ultraviolet rays, electron beams, α-rays, β-rays, and γ-ray's. In a case where the protective layer is cured by irradiation with ultraviolet rays after molding, the protective layer preferably contains a photopolymerization initiator from the viewpoint of curing properties. From the viewpoint of curing properties, the protective layer may further contain a photosensitizer, if necessary.

From the viewpoint of visibility and antireflection properties, the refractive index of the protective layer is preferably 1.05 to 1.6, more preferably 1.2 to 1.5, and still more preferably 1.2 to 1.4. The refractive index is a refractive index with respect to light having a wavelength of 550 nm at 25° C. In a case where the laminate is used for an exterior of an automobile, in order to prevent stains due to wax and gasoline from being conspicuous, it is preferable that the refractive index of the protective layer is set in a range close to the refractive index of wax and gasoline (for example, 1.4 to 1.5).

From the viewpoint of scratch resistance and three-dimensional moldability, the thickness of the protective layer is preferably 2 μm or more, more preferably 4 μm or more, still more preferably 4 μm to 50 μm, and particularly preferably 4 μm to 20 μm.

The protective layer is formed, for example, by applying a composition for forming a protective layer and, if necessary; drying the applied composition. The protective layer is formed, for example, by bonding a filmed protective layer.

Examples of the applying method include spray coating, brush coating, roller coating, bar coating, and dip coating.

Before applying the composition for forming a protective layer, a target object onto which the composition for forming a protective layer is applied may be subjected to a surface treatment. Examples of the surface treatment include a corona discharge treatment, a glow treatment, an atmospheric pressure plasma treatment, a flame treatment, and an ultraviolet irradiation treatment.

The drying of the composition for forming a protective layer may be carried out at room temperature (25° C.). The drying of the composition for forming a protective layer may be carried out by heating. From the viewpoint of volatility of the solvent contained in the composition for forming a protective layer, light transmittance of the protective layer, suppression of coloration of the protective layer, and suppression of decomposition of the resin substrate, it is preferable that the drying of the composition for forming a protective layer is carried out by heating at 40° C. to 200° C. From the viewpoint of suppressing thermal deformation of the resin substrate, it is preferable that the drying of the composition for forming a protective layer is carried out by heating at 40° C. to 120° C. A heating time is preferably 1 minute to 30 minutes.

A manufacturing method of the composition for forming a protective layer is not limited. The composition for forming a protective layer is manufactured, for example, by mixing an organic solvent, a surfactant, and water to disperse the organic solvent in water, and then adding a specific siloxane compound to the dispersion liquid to form a shell layer on a surface of the dispersed organic solvent to form core-shell particles. The composition for forming a protective layer is manufactured, for example, by mixing an organic solvent, a surfactant, a resin, and a monomer.

The composition for forming a protective layer preferably contains a surfactant. Examples of the surfactant include a nonionic surfactant, an anionic surfactant, a cationic surfactant, and an amphoteric surfactant.

The composition for forming a protective layer may contain other components depending on the intended purpose, in addition to the components described above. Examples of the other components include an antistatic agent and a preservative.

The composition for forming a protective layer may contain an antistatic agent. The antistatic agent imparts antistatic properties to the protective layer, which makes it possible to suppress the adhesion of contaminants.

The antistatic agent is preferably at least one antistatic agent selected from the group consisting of a metal oxide particle, a metal nanoparticle, a conductive polymer, and an ionic liquid.

In order to impart antistatic properties, a relatively large amount of metal oxide particles may be used. Above all, in a case where the protective layer contains metal oxide particles, the antifouling properties of the protective layer can be improved.

Examples of the metal oxide particles include tin oxide particles, antimony-doped tin oxide particles, tin-doped indium oxide particles, zinc oxide particles, and silica particles.

From the viewpoint of light transmittance, an average primary particle diameter of the metal oxide particles is preferably 100 nm or less, more preferably 50 nm or less, and particularly preferably 30 nm or less. The average primary particle diameter of the metal oxide particles is preferably 2 nm or more.

The average primary particle diameter of the metal oxide particles is calculated from images of 300 or more particles observed with a transmission electron microscope. A projected area of the particles is obtained from the image, and an equivalent circle diameter is obtained based on the projected area, whereby an average particle diameter (average primary particle diameter) is calculated. In a case where the shape of the metal oxide particles is not spherical, the average primary particle diameter may be calculated by another method (for example, a dynamic light scattering method).

The shape of the metal oxide particles may be spherical, plate-like, or needle-like.

The composition for forming a protective layer may contain one type of antistatic agent or two or more types of antistatic agents. Two or more types of antistatic agents having different compositions may be used. Two or more types of antistatic agents having different average primary particle diameters may be used. Two or more types of antistatic agents having different shapes may be used.

From the viewpoint of effectively imparting the antistatic properties to the protective layer without reducing the film-forming properties, the proportion of the content of the antistatic agent with respect to the total mass of the solid content of the composition for forming a protective layer is preferably 40% by mass or less, more preferably 30% by mass or less, and particularly preferably 20% by mass or less. In a case where the metal oxide particles are used as the antistatic agent, the proportion of the content of the metal oxide particles with respect to the total mass of the solid content of the composition for forming a protective layer is preferably 30% by mass or less, more preferably 20% by mass or less, and particularly preferably 10% by mass or less.

### [Resin Layer]

The laminate may have, for example, a resin layer between the first cured liquid crystal layer and the colored layer. Having the resin layer makes it possible to ensure the leveling of the first cured liquid crystal layer.

The resin layer preferably contains a different type of resin from the resin contained in the protective layer.

From the viewpoint of visibility, the resin layer is preferably a transparent resin layer and more preferably a layer consisting of a transparent film. The term “transparent” as used in reference to the transparent film means that the total light transmittance is 85% or more. The total light transmittance of the transparent film is measured by the method described above.

The transparent film is preferably a film obtained by forming a film of a transparent resin. Examples of the transparent film include a resin film containing at least one resin selected from the group consisting of polyethylene terephthalate (PET), polyethylene naphthalate (PEN), an acrylic resin, polycarbonate (PC), triacetyl cellulose (TAC), and a cycloolefin polymer (COP).

From the viewpoint of shape followability to a mold, a resin film containing an acrylic resin, a polycarbonate resin, or a polyethylene terephthalate resin in an amount of 60% by mass or more (more preferably 80% by mass or more and still more preferably 100% by mass) with respect to the total mass of the resin contained in the transparent film is preferable. A resin film containing an acrylic resin in an amount of 60% by mass or more (more preferably 80% by mass or more and still more preferably 100% by mass) with respect to the total mass of the resin contained in the transparent film is more preferable.

Examples of commercially available products of the transparent film include ACRYPLEN® HBS010 (acrylic resin film, manufactured by Mitsubishi Chemical Corporation), TECHNOLLOY® S001G (acrylic resin film, manufactured by Sumitomo Chemical Co., Ltd.), C000 (polycarbonate resin film, manufactured by Sumitomo Chemical Co., Ltd.), and C001 (acrylic resin/polycarbonate resin laminated film, manufactured by Sumitomo Chemical Co., Ltd.).

A thickness of the resin layer is preferably 50 μm to 150 μm.

Examples of the method for forming the resin layer include a method of bonding a transparent film and a liquid crystal layer or a colored layer to each other. Examples of a device used in the bonding step include a laminator, a vacuum laminator, and an auto-cut laminator. It is preferable that the laminator is equipped with a heatable roller such as a rubber roller and has a function of pressurizing and heating. The heating using a laminator can partially melt at least one of the transparent film or the liquid crystal layer to improve the adhesiveness between the liquid crystal layer and the transparent film. The heating temperature is determined depending on, for example, the material of the transparent film and the melting temperature of the liquid crystal layer. The heating temperature is preferably such that the temperature of the transparent film is 60° C. to 150° C. The heating temperature is more preferably such that the temperature of the transparent film is 65° C. to 130° C. The heating temperature is still more preferably such that the temperature of the transparent film is 70° C. to 100° C. A linear pressure in the bonding step is preferably 60 N/cm to 200 N/cm, more preferably 70 N/cm to 160 N/cm, and still more preferably 80 N/cm to 120 N/cm.

### [Cover Film]

From the viewpoint of preventing stains, the laminate may include a cover film as an outermost layer. Examples of the cover film include a film having flexibility and peelability. Examples of the cover film include a resin film such as a polyethylene film. The cover film is introduced into the laminate, for example, by bonding the cover film and the protective layer.

### [Other Layers]

The laminate may include other layers. Examples of the other layers include a self-repair layer, an antistatic layer, an antifouling layer, an electromagnetic wave shielding layer, and a conductive layer. Examples of the other layers include layers included in a known laminate. The other layers are formed, for example, by applying a composition containing the components of the other layers and, if necessary, drying the applied composition.

### [Layer Configuration]

Specific examples of a layer configuration of the laminate are shown below. However, the layer configuration of the laminate is not limited to the following specific examples. In addition, it is assumed that the left side is a viewing side. In addition, depending on the use application of the laminate, each layer may be independently provided as a single layer or may be provided in two or more layers.
(1) First cured liquid crystal layer/adhesive layer/substrate
(2) Second cured liquid crystal layer/first cured liquid crystal layer/adhesive layer/substrate
(3) First cured liquid crystal layer/adhesive layer/substrate/colored layer
(4) Second cured liquid crystal layer/first cured liquid crystal layer/adhesive layer/substrate/colored layer
(5) First cured liquid crystal layer/adhesive layer/substrate/second adhesive layer/colored layer
(6) Second cured liquid crystal layer/first cured liquid crystal layer/adhesive layer/substrate/second adhesive layer/colored layer
(7) Protective layer/first cured liquid crystal layer/adhesive layer/substrate
(8) Protective layer/second cured liquid crystal layer/first cured liquid crystal layer/adhesive layer/substrate
(9) Ultraviolet absorbing layer/first cured liquid crystal layer/adhesive layer/substrate
(10) Ultraviolet absorbing layer/second cured liquid crystal layer/first cured liquid crystal layer/adhesive layer/substrate
(11) Cover film/first cured liquid crystal layer/adhesive layer/substrate
(12) Cover film/second cured liquid crystal layer/first cured liquid crystal layer/adhesive layer/substrate

In addition, in a case where the laminate is used as a decorative film or the like of a display; examples of the arrangement include the following.
(13) First cured liquid crystal layer/adhesive layer/substrate/phase difference film/display
(14) Second cured liquid crystal layer/first cured liquid crystal layer/adhesive layer/substrate/phase difference film/display

The use application of the laminate according to the present disclosure is not particularly limited, and the laminate according to the present disclosure can be used, for example, for the decoration of a display device of a decorative film, a decorative panel, an electronic device (for example, a wearable device or a smartphone), a home appliance, an audio product, a computer, a display; an in-vehicle product, or the like. Above all, the laminate according to the present disclosure can be suitably used for the decoration of an electronic device (for example, a wearable device or a smartphone).

In addition, the laminate according to the present disclosure is also excellent in three-dimensional moldability, and thus is suitable as a decorative film for molding, which is used for molding such as three-dimensional molding and insert molding, and more suitable as a decorative film for three-dimensional molding.

### [Manufacturing Method of Laminate]

A manufacturing method of a laminate according to the present disclosure is not particularly limited, and a known method may be used or the laminate may be produced by applying a known method.

The manufacturing method of a laminate according to the present disclosure preferably includes, in the following order, for example, preparing a composition containing a liquid crystal compound having a polymerizable group, an optically active compound, and a photopolymerization initiator (hereinafter, referred to as a “preparing step”), applying the composition onto a peelable substrate (hereinafter, referred to as a “applying step”), curing the composition with light to form a cholesteric liquid crystal layer (hereinafter, referred to as a “curing step”), and laminating the cholesteric liquid crystal layer on another substrate through an adhesive layer (hereinafter, referred to as an “adhesive layer forming step”).

### (Preparing Step)

In the preparing step, a composition containing a liquid crystal compound having a polymerizable group, an optically active compound, and a photopolymerization initiator is prepared. Further, the optically active compound preferably includes an optically active compound having a polymerizable group, and more preferably includes an optically active compound having one polymerizable group.

It is considered that the optically active compound having one polymerizable group (hereinafter, also referred to as a “monofunctional optically active compound”) is introduced into a polymer chain by reaction with a cholesteric liquid crystal compound having a polymerizable group or a polymer thereof. On the other hand, it is considered that the monofunctional optical active compound cannot crosslink polymers with each other. As a result, not only the content of the low-molecular-weight compound in the liquid crystal layer formed through the curing step is reduced, and but also a liquid crystal layer having excellent stretchability is formed through the curing step.

The aspects of the composition and the aspects of each component contained in the composition are as described above. For example, from the viewpoint of controlling a crosslinking density, the cholesteric liquid crystal compound having a polymerizable group preferably includes a cholesteric liquid crystal compound having a polymerizable group. In addition, it is also preferable that the cholesteric liquid crystal compound having a polymerizable group includes a cholesteric liquid crystal compound having one polymerizable group and a cholesteric liquid crystal compound having two or more polymerizable groups.

### (Applying Step)

In the applying step, the composition is applied onto a peelable substrate. In the applying step, the composition may be applied onto a surface of the peelable substrate. In the applying step, the composition may be applied onto the peelable substrate through another layer. In the applying step, it is preferable to apply the composition onto the surface of the peelable substrate.

Examples of the peelable substrate include a substrate that can be peeled off from a laminate after forming the laminate. Examples of the peelable substrate include a laminate including a substrate and an easy adhesion layer. Examples of the substrate include the substrates described in the section of “Substrate” described above. Examples of commercially available products of the peelable substrate include COSMOSHINE A4160 (manufactured by Toyobo Co., Ltd.). The peelable substrate (preferably the substrate included in the peelable substrate) may be subjected to an alignment treatment.

In the applying step, the state of the composition may be a solution containing a solvent. In the applying step, the state of the composition may be a liquid by melting.

The composition may be applied by a roll coating method, a gravure printing method, or a spin coating method. The composition may be applied by a wire bar coating method, an extrusion coating method, a direct gravure coating method, a reverse gravure coating method, or a die-coating method. The composition may be applied using an ink jet device. In the applying method using an ink jet device, the composition may be jetted from a nozzle.

The composition applied onto the peelable substrate may be dried by a known method. The composition may be left to dry. The composition may be dried by air drying. The composition may be dried by heating. In the composition that has been subjected to the application and the drying, it is preferable that the cholesteric liquid crystal compound is aligned.

### (Curing Step)

In the curing step, the composition is cured with light to form a first cured liquid crystal layer. In the curing step, the alignment state of the molecules of the liquid crystal compound in the composition prepared in the preparing step can be maintained and fixed. In the exposure step, not only the composition but also the constituent elements other than the composition may be cured.

The light source may be selected depending on the type and characteristics of the photopolymerization initiator. A light source capable of emitting light having at least one wavelength selected from the group consisting of 285 nm, 365 nm, and 405 nm is preferable. Examples of the light source include a light emitting diode that emits ultraviolet rays (UV-LED), an ultra-high pressure mercury lamp, a high pressure mercury lamp, and a metal halide lamp.

The exposure amount is preferably 5 mJ/cm² to 2,000 mJ/cm² and more preferably 10 mJ/cm² to 1,000 mJ/cm².

The exposure step may include curing the composition with light under heating conditions. The heating in the exposure step can facilitate alignment of the liquid crystal compound. The heating temperature may be determined depending on the composition of the composition. The heating temperature may be 30° C. to 120° C.

An oxygen concentration in the curing step is not limited. The curing step may be carried out under an oxygen atmosphere. The curing step may be carried out under air. The curing step may be carried out under a low oxygen atmosphere (preferably at an oxygen concentration of 1,000 ppm or less). The oxygen concentration may be 0 ppm. The oxygen concentration may be more than 0 ppm and 1,000 ppm or less. From the viewpoint of accelerating curing, the curing step is preferably carried out under a low oxygen atmosphere, and more preferably carried out under heating and under a low oxygen atmosphere.

For example, the method described in paragraphs to of JP2006-23696A may be applied as the exposure method.

### (Adhesive Layer Forming Step)

In the adhesive layer forming step, the first cured liquid crystal layer is laminated on another substrate through an adhesive layer. In the adhesive layer forming step, an adhesive layer adjacent to the first cured liquid crystal layer may be formed. In the adhesive layer forming step, an adhesive layer may be formed on the first cured liquid crystal layer through another layer. In the adhesive layer forming step, it is preferable to form an adhesive layer adjacent to the first cured liquid crystal layer. The method of forming the adhesive layer is as described above.

### (Other Steps)

The manufacturing method of a laminate may include other steps. Depending on the desired layer configuration, the manufacturing method of a laminate may include forming a layer other than the first cured liquid crystal layer and the adhesive layer. The manufacturing method of a laminate may include photoisomerizing an uncured liquid crystal layer (also simply referred to as a “liquid crystal layer”) (hereinafter, referred to as a “photoisomerization step”).

The photoisomerization step preferably includes photoisomerizing a photoisomerization compound contained in the liquid crystal layer. From the viewpoint of designability and lustrousness, it is preferable to carry out isomerization such that a difference in photoisomerization ratio between the regions occurs in the liquid crystal layer, and it is more preferable to carry out isomerization such that a difference in photoisomerization ratio between the regions occurs in the liquid crystal layer depending on the shape to be molded. In the photoisomerization step, a part of the liquid crystal layer may be isomerized, or a part of the liquid crystal layer may be isomerized depending on the shape to be molded. In the photoisomerization step, the isomerization ratio of the photoisomerization compound may be changed depending on the shape to be molded. In the photoisomerization step, a portion where the isomerization ratio is 0% and a portion where the isomerization ratio is 100% may be formed in the liquid crystal layer. In the photoisomerization step, a portion where the isomerization ratio is 10% and a portion where the isomerization ratio is 80% may be formed in the liquid crystal layer. In the photoisomerization step, a portion where the isomerization ratio changes from 0) % to 100% may be formed in the liquid crystal layer. In the photoisomerization step, a portion where the isomerization ratio is 0% and a portion where the isomerization ratio changes from 50% to 100% may be formed in the liquid crystal layer. In particular, it is preferable that the isomerization ratio is larger in a portion where a stretching rate of the laminate is larger during molding, depending on the shape to be molded. The progress of photoisomerization is confirmed by measuring the maximum wavelength of reflectivity of the isomerized portion. The photoisomerization ratio represents a ratio of the number of molecules of the photoisomerized photoisomerization compound to the total number of molecules of the target photoisomerization compound, and is similarly obtained by measuring the maximum wavelength of reflectivity.

In the photoisomerization step, it is preferable to carry out isomerization by changing the exposure intensity to the liquid crystal layer depending on the region. For example, isomerization may be carried out by exposure with a plurality of steps of differences or stepless continuous differences in exposure intensity to the liquid crystal layer. It is preferable to carry out isomerization by exposing only a part of the liquid crystal layer. The isomerization ratio may be controlled depending on the exposure intensity.

The wavelength of light emitted to the liquid crystal layer may be determined depending on the photoisomerization compound. In the photoisomerization step, light in a wavelength range of 400 nm or less is preferably used, light in a wavelength range of 380 nm or less is more preferably used, and light in a wavelength range of 300 nm or more and 380 nm or less is still more preferably used.

The adjustment of the wavelength of light may be carried out by a known means and a known method. Examples of a method of adjusting the wavelength of light include a method of using an optical filter, a method of using two or more types of optical filters, and a method of using a light source having a specific wavelength.

In the photoisomerization step, it is preferable that the liquid crystal layer is irradiated with light in a wavelength range in which a polymerization initiation species is not generated from a photopolymerization initiator. For example, a mask that transmits light in a wavelength range in which the photoisomerization of a photoisomerization compound occurs and shields light in a wavelength range in which a polymerization initiation species is generated from a photopolymerization initiator is preferably used. The mask may be a known mask. The mask may be a mask produced by gravure printing, screen printing, or a method of patterning a sputtered chromium film with a photoresist. The mask may be a mask produced by using a laser printer or an ink jet printer. One type of mask or two or more types of masks may be used. For example, different masks may be used for the portion of the liquid crystal layer that is subjected to photoisomerization and the portion of the liquid crystal layer that is not subjected to photoisomerization. In the portion of the liquid crystal layer that is subjected to photoisomerization, a mask may be used in which the amount of transmitted light is not constant and the amount of transmitted light is variable.

Examples of the light source include an ultra-high pressure mercury lamp, a high pressure mercury lamp, and a metal halide lamp. Examples of the light source include a light emitting diode that can emit light in a narrow wavelength range. In a case where a light source capable of emitting light in a narrow wavelength range is used, the mask may or may not be used.

The exposure amount in the photoisomerization step is preferably 5 mJ/cm² to 2,000 mJ/cm² and more preferably 10 mJ/cm² to 1,000 mJ/cm². The exposure amount may be changed in each portion of the liquid crystal layer depending on the desired isomerization ratio.

The isomerization by exposure is preferably carried out under heating conditions. The heating temperature is, for example, 30° C. to 100° C.

For example, the method described in paragraphs to of JP2006-23696A may be applied as the exposure method in the photoisomerization step.

In addition, examples of the other steps include a step of peeling off the substrate from a laminate manufactured in an aspect that includes the substrate, and a decorative film of an aspect that does not include the substrate can be manufactured.

Further, examples of the other steps include a colored layer forming step, an alignment layer forming step, and a step of forming another layer. The details and the forming methods of the colored layer and the alignment layer are as described above. In addition, the details of the other layer are as described above, and a known method may be used as a method of forming the other layer.

### <Decorative Film, Article, Decorative Panel, and Display Device>

The laminate according to the present disclosure can be used for various use applications, and for example, the laminate can be molded and used as a molded body:

A decorative film according to the present disclosure includes the laminate according to the present disclosure, and may be formed by molding the laminate according to the present disclosure.

An article according to the present disclosure is an article including the laminate according to the present disclosure.

Such a laminate can be provided in a variety of articles.

Examples of such an article include an electronic device such as a smartphone, a mobile phone, or a tablet, an automobile, an electric appliance, and a packaging container, and in particular, the laminate according to the present disclosure can be suitably used for an electronic device. More suitable examples of the electronic device include a display device such as a display; a smartphone, a mobile phone, or a tablet. Above all, the laminate according to the present disclosure can be particularly suitably used for a normal display or a display in a display device of a smartphone, a home appliance, an audio product, a computer, an in-vehicle product, or the like.

In addition, in a case where the laminate according to the present disclosure is used in a display device such as a display or a smartphone, a phase difference film may be provided between the laminate according to the present disclosure and a display member such as a display.

A known phase difference film can be used as the phase difference film.

The means for molding the laminate according to the present disclosure to obtain a molded body is not particularly limited, and may be, for example, a known method such as three-dimensional molding or insert molding. In addition, the means for applying the laminate according to the present disclosure to an article is also not particularly limited, and a known method may be appropriately used depending on the type of the article.

A decorative panel according to the present disclosure includes the decorative film according to the present disclosure.

A shape of the decorative panel is not limited. The shape of the decorative panel may be determined depending on the use application, for example. The decorative panel may have, for example, a flat plate shape. In addition, the decorative panel may have a curved surface.

The decorative panel can be used, for example, for the interior and exterior of various articles. Examples of the article include the above-described articles (for example, an electronic device, an automobile, and an electrical product).

The decorative panel can be manufactured, for example, by adhesion of a surface of the decorative film on the layer side that exhibits a structural color to a surface of a member serving as a surface layer portion of the decorative panel. Examples of the member serving as a surface layer portion of the decorative panel include a glass panel. For adhesion of the decorative film to the member serving as a surface layer portion of the decorative panel, for example, the above-mentioned pressure-sensitive adhesive layer can be used. For example, a molded decorative film may be used alone as the decorative panel without combining the decorative film and another member.

A display device according to the present disclosure is a display device including the decorative panel according to the present disclosure.

Examples of the display device include a display, a smartphone, a mobile phone, and a tablet.

### EXAMPLES

Hereinafter, the present disclosure will be described in detail with reference to Examples. However, the present disclosure is not limited to the following Examples, and the contents (for example, raw materials, conditions, and methods) described in the following Examples may be appropriately modified within the scope of the object of the present disclosure. In the following description, unless otherwise specified, “%” means “% by mass”.

### <Peelable Substrate>

A polyethylene terephthalate film (COSMOSHINE A4160, manufactured by Toyobo Co., Ltd., film thickness: 100 μm; PET) having an easy adhesion layer on one surface was prepared as the peelable substrate. Of both surfaces of the peelable substrate, a surface of the peelable substrate on which the easy adhesion layer was not formed was subjected to a rubbing treatment (rayon cloth, pressure: 0.1 kgf, rotation speed: 1,000 revolutions per minute (rpm), transportation speed: 10 m/min, number of times: 1 time).

### <Method of Preparing Coating Liquid 1 for Forming Liquid Crystal Layer>

A coating liquid 1 for forming a liquid crystal layer having the composition shown below was prepared.
Liquid crystal compound 1:31.39 parts by mass
Chiral agent 1:1.77 parts by mass
Photopolymerization initiator (diethylthioxanthone, manufactured by FUJIFILM Wako Pure Chemical Corporation): 0.31 parts by mass
Surfactant 1:0.016 parts by mass
Surfactant 2:0.017 parts by mass
Methyl ethyl ketone (solvent): 55.86 parts by mass
Furfuryl alcohol (solvent): 10.64 parts by mass

Details of the components other than those described above are shown below.
Liquid crystal compound 1: a compound shown below

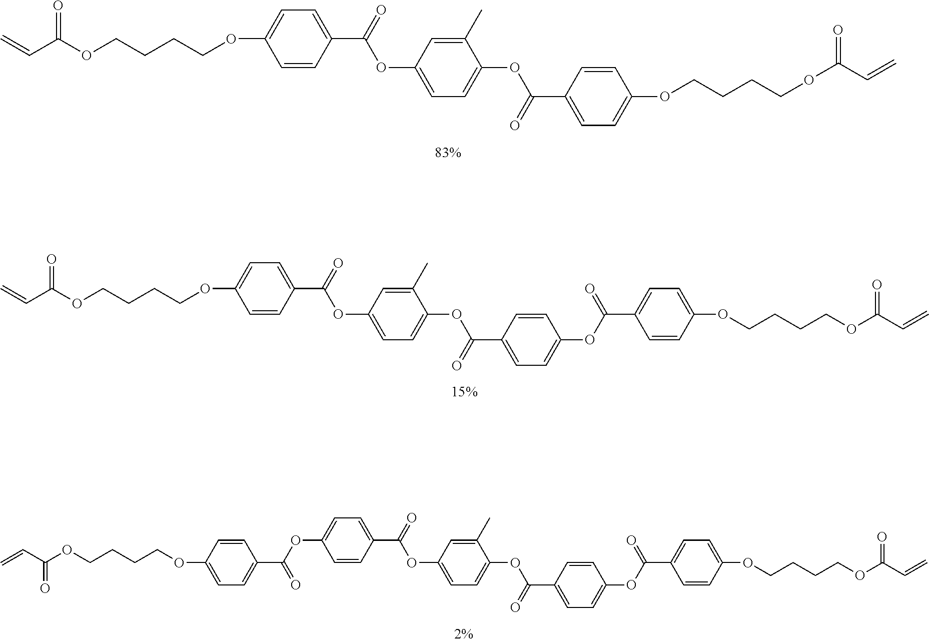

Chiral agent 1: a compound shown below

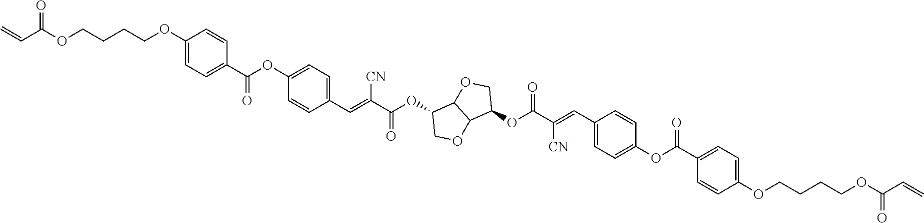 [SMILES: C=CC(=O)OCCCCOc1ccc(C(=O)Oc2ccc(/C=C(\C#N)C(=O)O[C@H]3COC4C3OC[C@H]4OC(=O)/C(C#N)=C/c3ccc(OC(=O)c4ccc(OCCCCOC(=O)C=C)cc4)cc3)cc2)cc1]

Surfactant 1: a compound shown below

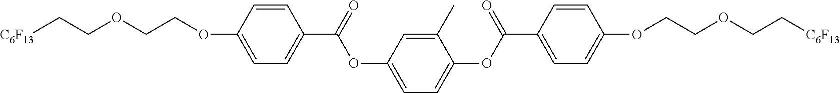

Surfactant 2: a compound shown below

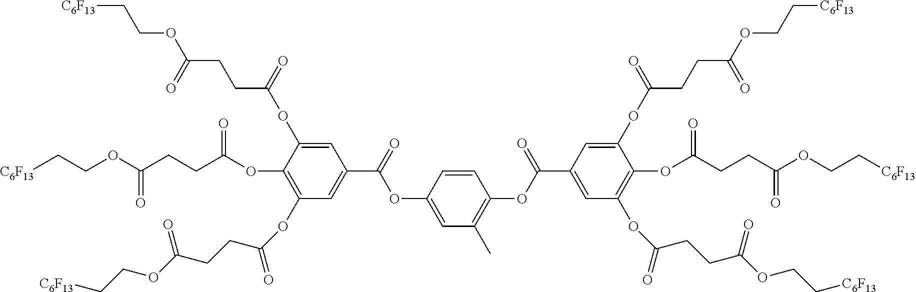

### <Method of Preparing Coating Liquid 2 for Forming Liquid Crystal Layer>

A coating liquid 2 for forming a liquid crystal layer having the composition shown below was prepared.
Liquid crystal compound 1:29.69 parts by mass
Chiral agent 2:2.59 parts by mass
Photopolymerization initiator (diethylthioxanthone, manufactured by FUJIFILM Wako Pure Chemical Corporation): 1.19 parts by mass
Surfactant 1:0.015 parts by mass
Surfactant 2:0.016 parts by mass
Methyl ethyl ketone (solvent): 60.52 parts by mass
Furfuryl alcohol (solvent): 5.99 parts by mass

Details of the components other than those described above are shown below.
Chiral agent 2: a compound shown below

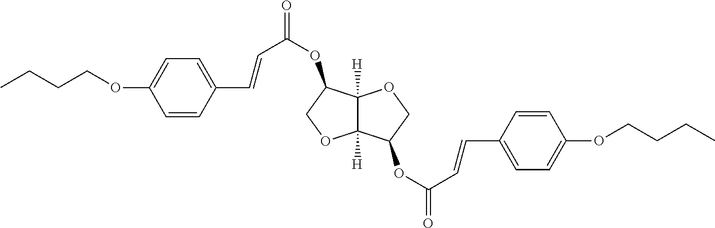 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

### <Method of Preparing Coating Liquid 3 for Forming Liquid Crystal Layer>

A coating liquid 3 for forming a liquid crystal layer having the composition shown below was prepared.
Liquid crystal compound 1:22.91 parts by mass
Liquid crystal compound 2:8.47 parts by mass
Chiral agent 1:1.77 parts by mass
Photopolymerization initiator (diethylthioxanthone, manufactured by FUJIFILM Wako Pure Chemical Corporation): 0.31 parts by mass
Surfactant 1:0.016 parts by mass
Surfactant 2:0.017 parts by mass
Methyl ethyl ketone (solvent): 55.86 parts by mass
Furfuryl alcohol (solvent): 10.64 parts by mass

Details of the components other than those described above are shown below.
Liquid crystal compound 2: a compound shown below, where Me represents a methyl group

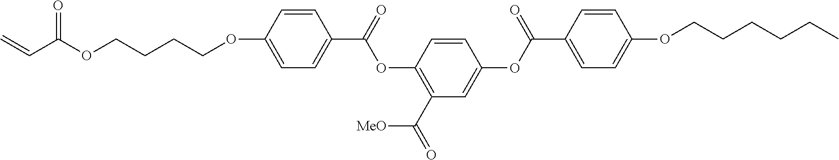 [SMILES: C=CC(=O)OCCCCOc1ccc(C(=O)Oc2ccc(OC(=O)c3ccc(OCCCCCC)cc3)cc2C(=O)OC)cc1]

### <Method of Preparing Coating Liquid 4 for Forming Liquid Crystal Layer>

A coating liquid 4 for forming a liquid crystal layer having the composition shown below was prepared.
Liquid crystal compound 1:21.97 parts by mass
Liquid crystal compound 2:7.72 parts by mass
Chiral agent 2:2.59 parts by mass
Photopolymerization initiator (diethylthioxanthone, manufactured by FUJIFILM Wako
Pure Chemical Corporation): 1.19 parts by mass
Surfactant 1:0.015 parts by mass
Surfactant 2:0.016 parts by mass
Methyl ethyl ketone (solvent): 60.52 parts by mass
Furfuryl alcohol (solvent): 5.99 parts by mass

### <Method of Preparing Coating Liquid 5 for Forming Liquid Crystal Layer>

A coating liquid 5 for forming a liquid crystal layer having the composition shown below was prepared.
Liquid crystal compound 1:6.28 parts by mass
Liquid crystal compound 2:25.11 parts by mass
Chiral agent 1:1.77 parts by mass
Photopolymerization initiator (diethylthioxanthone, manufactured by FUJIFILM Wako
Pure Chemical Corporation): 0.31 parts by mass
Surfactant 1:0.016 parts by mass
Surfactant 2:0.017 parts by mass
Methyl ethyl ketone (solvent): 55.86 parts by mass
Furfuryl alcohol (solvent): 10.64 parts by mass

### <Method of Preparing Coating Liquid 6 for Forming Liquid Crystal Layer>

A coating liquid 6 for forming a liquid crystal layer having the composition shown below was prepared.
Liquid crystal compound 1:6.83 parts by mass
Liquid crystal compound 2:22.87 parts by mass
Chiral agent 2:2.59 parts by mass
Photopolymerization initiator (diethylthioxanthone, manufactured by FUJIFILM Wako
Pure Chemical Corporation): 1.19 parts by mass
Surfactant 1:0.015 parts by mass
Surfactant 2:0.016 parts by mass
Methyl ethyl ketone (solvent): 60.52 parts by mass
Furfuryl alcohol (solvent): 5.99 parts by mass

### Method of Preparing Coating Liquid 7 for Forming Liquid Crystal Layer

A coating liquid 7 for forming a liquid crystal layer having the composition shown below was prepared.
Liquid crystal compound 1:31.00 parts by mass
Chiral agent 1:2.16 parts by mass
Photopolymerization initiator: 0.31 parts by mass
Diethylthioxanthone (manufactured by FUJIFILM Wako Pure Chemical Corporation)
Surfactant 1:0.016 parts by mass
Surfactant 2:0.017 parts by mass
Methyl ethyl ketone (solvent): 55.86 parts by mass
Furfuryl alcohol (solvent): 10.64 parts by mass

### Method of Preparing Coating Liquid 8 for Forming Liquid Crystal Layer

A coating liquid 8 for forming a liquid crystal layer having the composition shown below was prepared.
Liquid crystal compound 1:30.12 parts by mass
Chiral agent 2:2.15 parts by mass
Photopolymerization initiator: 1.21 parts by mass
Diethylthioxanthone (manufactured by FUJIFILM Wako Pure Chemical Corporation)
Surfactant 1:0.015 parts by mass
Surfactant 2:0.017 parts by mass
Methyl ethyl ketone (solvent): 60.52 parts by mass
Furfuryl alcohol (solvent): 5.99 parts by mass

### Method of Preparing Coating Liquid 9 for Forming Liquid Crystal Layer

A coating liquid 9 for forming a liquid crystal layer having the composition shown below was prepared.
Liquid crystal compound 1:31.60 parts by mass
Chiral agent 3:1.55 parts by mass

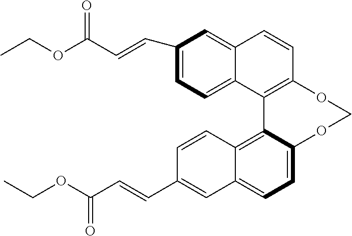

Photopolymerization initiator: 0.32 parts by mass
Diethylthioxanthone (manufactured by FUJIFILM Wako Pure Chemical Corporation)
Surfactant 1:0.016 parts by mass
Surfactant 2:0.017 parts by mass
Methyl ethyl ketone (solvent): 56.53 parts by mass
Furfuryl alcohol (solvent): 10.00 parts by mass

### Method of Preparing Coating Liquid 10 for Forming Liquid Crystal Layer

A coating liquid 10 for forming a liquid crystal layer having the composition shown below was prepared.
Liquid crystal compound 1:31.75 parts by mass
Chiral agent 4:1.40 parts by mass

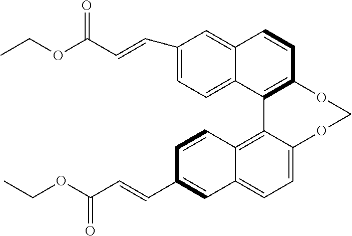

Photopolymerization initiator: 0.32 parts by mass
Diethylthioxanthone (manufactured by FUJIFILM Wako Pure Chemical Corporation)
Surfactant 1:0.016 parts by mass
Surfactant 2:0.017 parts by mass
Methyl ethyl ketone (solvent): 56.53 parts by mass
Furfuryl alcohol (solvent): 10.00 parts by mass

### Method of Preparing Coating Liquid 11 for Forming Liquid Crystal Layer

A coating liquid 11 for forming a liquid crystal layer having the composition shown below was prepared.
Liquid crystal compound 3:20.84 parts by mass

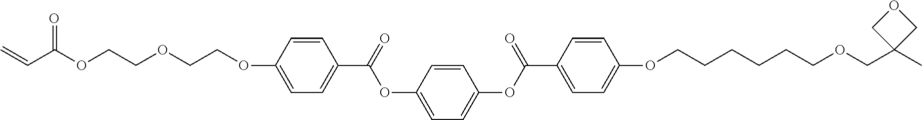 [SMILES: C=CC(=O)OCCOCCOc1ccc(C(=O)Oc2ccc(OC(=O)c3ccc(OCCCCCCOCC4(C)COC4)cc3)cc2)cc1]

Liquid crystal compound 4:5.21 parts by mass

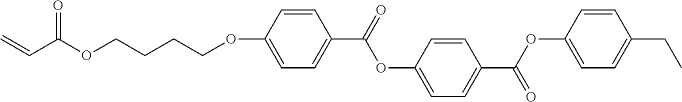 [SMILES: C=CC(=O)OCCCCOc1ccc(C(=O)Oc2ccc(C(=O)Oc3ccc(CC)cc3)cc2)cc1]

Liquid crystal compound 5:5.21 parts by mass

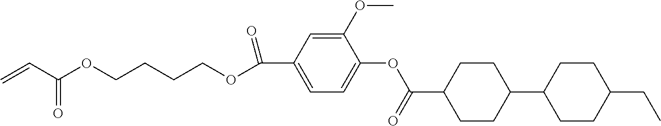 [SMILES: C=CC(=O)OCCCCOC(=O)c1ccc(OC(=O)C2CCC(C3CCC(CC)CC3)CC2)c(OC)c1]

Chiral agent 5:0.65 parts by mass
LC-756 (manufactured by BASF SE)
Chiral agent 6:1.30 parts by mass

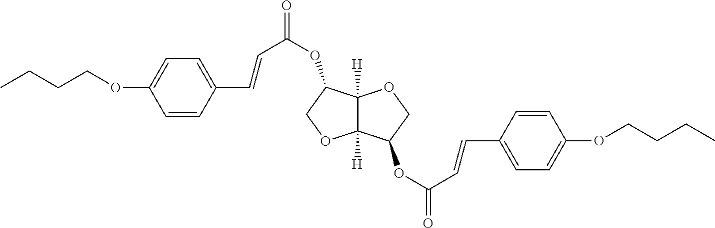 [SMILES: CCCCOc1ccc(/C=C/C(=O)O[C@H]2CO[C@H]3[C@@H]2OC[C@H]3OC(=O)/C=C/c2ccc(OCCCC)cc2)cc1]

Photopolymerization initiator: 0.26 parts by mass
Diethylthioxanthone (manufactured by FUJIFILM Wako Pure Chemical Corporation)
Surfactant 1:0.013 parts by mass
Surfactant 2:0.014 parts by mass
Methyl ethyl ketone (solvent): 60.52 parts by mass
Furfuryl alcohol (solvent): 5.99 parts by mass

### Example 1

As described above, a rubbing-treated peelable substrate was prepared. Next, the coating liquid 1 for forming a liquid crystal layer was applied using a wire bar #8 to form a liquid crystal layer 1.

Next, a curing treatment was carried out on the liquid crystal layer 1 to cure the liquid crystal layer 1. Specifically, the liquid crystal layer 1 was cured by irradiating the liquid crystal layer 1 with light of a metal halide lamp (MAL625NAL, manufactured by GS Yuasa International Ltd.) on a hot plate at 85° C. in a low oxygen atmosphere (oxygen concentration of 1,000 ppm or less), thereby forming a cured liquid crystal layer 1. In this case, light having a wavelength of 340 nm or less was cut. An irradiation amount of light was 1,000 mJ/cm².

Subsequently, the coating liquid 2 for forming a liquid crystal layer was applied onto the cured liquid crystal layer 1 with a wire bar #8 to form a liquid crystal layer 2.

Next, a curing treatment was carried out in the same manner as in the liquid crystal layer 1, except that light having a wavelength of 340 nm or less was not cut, whereby the liquid crystal layer 2 was cured to obtain a cured liquid crystal layer 2. The reflection wavelength tint of cured liquid crystal layers 1 and 2 as visually recognized was green.

Next, an adhesive (UVX-6282, manufactured by Toagosei Co., Ltd.) was applied onto the cured liquid crystal layer 2, a substrate (COSMOSHINE A4360 (thickness: 50 μm), manufactured by Toyobo Co., Ltd., polyethylene terephthalate (PET) film) was further placed thereon, and the resulting structure was passed through a laminator.

Subsequently, the adhesive layer was cured by irradiation (1,000 mJ/cm²) with light of a metal halide lamp at 25° C.

Finally, the rubbing-treated peelable substrate was peeled off to obtain a laminate 1A. The thickness of the adhesive layer was 5 μm.

The laminate 1A obtained by the above procedure includes a substrate, an adhesive layer, a cured liquid crystal layer 2 (cholesteric liquid crystal layer), and a cured liquid crystal layer 1 (cholesteric liquid crystal layer) in this order.

### Example 2

Except for the following, the same procedure as in Example 1 was followed to form a cured liquid crystal layer 2.

Next, an adhesive layer was formed on the cured liquid crystal layer 2 using an adhesive (NCF-D692, manufactured by Lintec Corporation).

Next, a substrate (COSMOSHINE A4360 (thickness: 50 μm), manufactured by Toyobo Co., Ltd., PET film) was bonded onto the adhesive.

Finally, the rubbing-treated peelable substrate was peeled off to obtain a laminate 2A. The thickness of the adhesive layer was 5 μm.

### Example 3

A laminate 3A was obtained in the same manner as in Example 1, except that the adhesive was changed to UF-3007 manufactured by Kyoeisha Chemical Co., Ltd. The thickness of the adhesive layer was 5 μm.

### Example 4

A laminate 4A was obtained in the same manner as in Example 1, except that the substrate was changed to TECHNOLLOY C000 (polycarbonate (PC) resin single layer sheet) manufactured by Sumika Acryl Co., Ltd. The thickness of the adhesive layer was 5 μm.

### Example 5

A laminate 5A was obtained in the same manner as in Example 3, except that the thickness of the adhesive layer was changed. The thickness of the adhesive layer was 31 μm.

### Example 6

A liquid crystal layer 1 was formed on a peelable substrate by the same procedure as in Example 1.

Next, the liquid crystal layer 1 was subjected to a curing treatment to cure the liquid crystal layer. Specifically, a cured liquid crystal layer was obtained by irradiating the liquid crystal layer with light of a metal halide lamp (MAL625NAL, manufactured by GS Yuasa International Ltd.) on a hot plate at 85° C. in a low oxygen atmosphere (oxygen concentration: 1,000 ppm or less). An irradiation amount of light was 1,000 mJ/cm². The reflection wavelength tint of the cured liquid crystal layer as visually recognized was green.

Next, an adhesive (UF-3007, manufactured by Kyoeisha Chemical Co., Ltd.) was applied onto the cured liquid crystal layer, a substrate (COSMOSHINE A4360 (thickness: 50 μm), manufactured by Toyobo Co., Ltd.) was further placed thereon, and the resulting structure was passed through a laminator.

Subsequently, the adhesive layer was cured by irradiation (1,000 mJ/cm²) with light of a metal halide lamp at 25° C.

Finally, the rubbing-treated peelable substrate was peeled off to obtain a laminate 6A. The thickness of the adhesive layer was 5 μm.

### Example 7

A laminate 7A was obtained in the same manner as in Example 3, except that the coating liquid 1 for forming a liquid crystal layer was changed to a coating liquid 3 for forming a liquid crystal layer, and the coating liquid 2 for forming a liquid crystal layer was changed to a coating liquid 4 for forming a liquid crystal layer. The thickness of the adhesive layer was 5 μm.

### Example 8

A laminate 8A was obtained in the same manner as in Example 3, except that the coating liquid 1 for forming a liquid crystal layer was changed to a coating liquid 5 for forming a liquid crystal layer, and the coating liquid 2 for forming a liquid crystal layer was changed to a coating liquid 6 for forming a liquid crystal layer. The thickness of the adhesive layer was 5 μm.

### Example 9

A laminate 9A was obtained in the same manner as in Example 3, except that the coating liquid 1 for forming a liquid crystal layer was changed to a coating liquid 7 for forming a liquid crystal layer, and the coating liquid 2 for forming a liquid crystal layer was changed to a coating liquid 8 for forming a liquid crystal layer. The reflection wavelength tint of the laminate was magenta. The thickness of the adhesive layer was 5 μm.

### Example 10

A laminate 10A was obtained in the same manner as in Example 3, except that the coating liquid 1 for forming a liquid crystal layer was changed to a coating liquid 9 for forming a liquid crystal layer, and the coating liquid 2 for forming a liquid crystal layer was changed to a coating liquid 10 for forming a liquid crystal layer. The reflection wavelength tint of the laminate was blue-green. The thickness of the adhesive layer was 5 μm.

### Example 11

A laminate 11A was obtained in the same manner as in Example 3, except that the wire bar at the time of applying was changed to #4. The thickness of the adhesive layer was 5 μm.

### Example 12

A laminate 12A was obtained in the same manner as in Example 3, except that the thickness of the substrate was changed to 100 μm. The thickness of the adhesive layer was 5 μm.

### Example 13

The laminate 3A was obtained by the procedure of Example 3. Then, a nax REAL Super Black paint manufactured by Nippon Paint Co., Ltd. was applied onto the surface of the substrate using a wire bar #20 and dried at 100° C. for 2 minutes to obtain a laminate 13A with a colored layer having a thickness of 10 μm.

### Comparative Example 1

A liquid crystal layer 1 was formed on a peelable substrate by the same procedure as in Example 1.

Next, the liquid crystal layer 1 was subjected to a curing treatment to cure the liquid crystal layer. Specifically, a cured liquid crystal layer was obtained by irradiating the liquid crystal layer with light of a metal halide lamp (MAL625NAL, manufactured by GS Yuasa International Ltd.) on a hot plate at 85° C. in a low oxygen atmosphere (oxygen concentration: 1,000 ppm or less). An irradiation amount of light was 1,000 mJ/cm². The reflection wavelength tint of the cured liquid crystal layer as visually recognized was green.

Next, an adhesive layer was formed on the cured liquid crystal layer using an adhesive (NNE75, manufactured by Gunze Limited).

Next, a substrate (COSMOSHINE A4360 (thickness: 50 μm), manufactured by Toyobo Co., Ltd.) was bonded onto the adhesive.

Finally, the rubbing-treated peelable substrate was peeled off to obtain a laminate 1B. The thickness of the adhesive layer was 75 μm.

### Comparative Example 2

The same procedure as in Comparative Example 1 was followed to form a cured liquid crystal layer.

Next, the adhesive was changed to EP171 manufactured by Cemedine Co., Ltd., and the resulting structure was passed through a laminator in the same manner as in Example 1.

This was followed by heating and curing in an oven at 80° C. for 30 minutes and then at 120° C. for 10 minutes, and the rubbing-treated peelable substrate was peeled off to obtain a laminate 2B. The thickness of the adhesive layer was 1 μm.

### Comparative Example 3

A laminate 3B was obtained in the same manner as in Comparative Example 1, except that the adhesive was changed to G25 manufactured by NEION Film Coatings Corp. The thickness of the adhesive layer was 25 μm.

### Comparative Example 4

A laminate 4B was obtained in the same manner as in Example 6, except that the coating liquid 1 for forming a liquid crystal layer was changed to a coating liquid 11 for forming a liquid crystal layer, and the irradiation amount of light was changed to 60 mJ/cm².

### Comparative Example 5

A laminate 5B was obtained in the same manner as in Example 6, except that the substrate was changed to TORAYFAN NO ZK500 (thickness: 50 μm: CPP) manufactured by Toray Industries, Inc.

### <Measurement of Storage Elastic Modulus of Each Layer>

The storage elastic modulus was measured in such a manner that each sample of 5 mm×25 mm was subjected to humidity conditioning at a temperature of 25° C. and a relative humidity of 60% for 2 hours or longer, and then the storage elastic modulus of each layer was measured using a dynamic viscoelasticity measuring device (VIBRON: DVA-225, manufactured by IT Measurement Control Co., Ltd.) at a distance between grips of 10 mm, a temperature increase rate of 5° C./min, a measurement temperature range of −100° C. to 200° C., and a frequency of 10 Hz.

### <Evaluation of Bending Resistance>

Using a mandrel tester, the laminate was bent such that the cured liquid crystal layer in the direction opposite to the substrate was pulled. The minimum diameter at which cracks did not occur after bending was evaluated.

### (Evaluation Standards)

A: The minimum diameter was less than 5 mm.
B: The minimum diameter was 5 mm or more and less than 10 mm.
C: The minimum diameter was 10 mm or more.

### <Evaluation of Lustrousness>

The in-plane average reflectivity of the laminates manufactured in Examples and Comparative Examples was measured, and the lustrousness was evaluated based on the following evaluation standards.

The in-plane average reflectivity was measured as follows.

For each laminate, using a spectrophotometer (V-670, manufactured by JASCO Corporation) equipped with a large integrating sphere device (ILV-471, manufactured by JASCO Corporation), light having a wavelength of 300 nm to 900 nm was incident from a vertical direction (at an angle of 90° with respect to the surface of the cured liquid crystal layer), the peak wavelength was read from the obtained spectroscopic spectrum, and the reflectivity at the peak wavelength was obtained.

The reflectivity at the peak wavelength was measured on the entire surface of the cured liquid crystal layer as the outermost surface, and the average of the measured values was taken as the in-plane average reflectivity.

### (Evaluation Standards)

A: The in-plane average reflectivity was 50% or more.
B: The in-plane average reflectivity was 30% or more and less than 50%.
C: The in-plane average reflectivity was less than 30%.

### <Evaluation of Durability>

The transmittance of the target laminate was measured using a spectrophotometer (Spectrophotometer V670, manufactured by JASCO Corporation. The same applies hereinafter in this paragraph). Next, the laminate was allowed to stand in an oven at 80° C. for 240 hours, and a transmittance of the laminate after 240 hours was measured using the spectrophotometer.

A difference Δλs between a reflection band central wavelength of visible light, calculated based on the transmittance measured before the heating, and a reflection band central wavelength of visible light, calculated based on the transmittance measured after the heating, was obtained. The reflection band central wavelength was obtained by inversion of a transmittance graph obtained using the spectrophotometer, and the expression represented by λs=(λ1+λ2)/2 based on a wavelength λ1 on a short wavelength side and a wavelength 22 on a long wavelength side among two wavelengths showing a reflectivity of 30% of the reflectivity R in a case of a single layer and a reflectivity of 60% of the reflectivity R in a case of a laminate. The durability was evaluated according to the following standards. As Δλs is smaller, the change in tint in a thermal environment is smaller.

### (Evaluation Standards)

$$\begin{matrix}A : Δλ s \leq 10 nm \\ B : 10 nm < Δλ s < 20 nm \\ C : 20 nm \leq Δλ s\end{matrix}$$

| | | Substrate | | | | | | | | |
|---|---|---|---|---|---|---|---|---|---|---|
| | | | Storage | First cured liquid crystal layer | | | | | | |
| | | | elastic | | | | | Storage | Storage | |
| | | | modulus E1 | | Number | Film | | elastic | elastic | Crosslinking |
| | | Thickness | (25° C.) | | of | thickness | Reflection | modulus | modulus | density |
| | Substrate | ( [symbol] ) | (Pa) | Formulations | layers | (μm) | time | E3 (25° C.) (Pa) | (80° C.) (Pa) | (mol/L) |
| Comparative | PET | 50 | 5.0 × | Cured liquid | 1 | 4 | 550 | 1.9 × | 9.0 × | 1 |
| Example 1 | | | 10 [symbol] | crystal | | | | 10 [symbol] | 10 [symbol] | |
| | | | | layer 1 | | | | | | |
| Comparative | PET | 50 | 5.0 × | Cured liquid | 1 | 4 | 550 | 1.9 × | 9.0 × | 1 |
| Example 2 | | | 10 [symbol] | crystal | | | | 10 [symbol] | 10 [symbol] | |
| | | | | layer 1 | | | | | | |
| Comparative | PET | 50 | 5.0 × | Cured liquid | 1 | 4 | 550 | 1.9 × | 9.0 × | 1 |
| Example 3 | | | 10 [symbol] | crystal | | | | 10 [symbol] | 10 [symbol] | |
| | | | | layer 1 | | | | | | |
| Comparative | PET | 50 | 5.0 × | Cured liquid | 1 | 4 | 550 | 4.0 × | 5.0 × | 0.02 |
| Example 4 | | | 10 [symbol] | crystal | | | | 10 [symbol] | 10 [symbol] | |
| | | | | layer 1 [symbol] | | | | | | |
| Comparative | CPP | 50 | 3.0 × | Cured liquid | 1 | 4 | 550 | 1.9 × | 9.0 × | 1 |
| Example 5 | | | 10 [symbol] | crystal | | | | 10 [symbol] | 10 [symbol] | |
| | | | | layer 1 | | | | | | |
| Example | PET | 50 | 5.0 × | Cured liquid | 2 | 4/4 | 550/550 | 1.9 × | 9.0 × | 1 |
| 1 | | | 10 [symbol] | crystal | | | | 10 [symbol] | 10 [symbol] | |
| | | | | layer 1/Cured | | | | | | |
| | | | | liquid | | | | | | |
| | | | | crystal | | | | | | |
| | | | | layer 2 | | | | | | |
| Example | PET | 50 | 5.0 × | Cured liquid | 2 | 4/4 | 550/550 | 1.9 × | 9.0 × | 1 |
| 2 | | | 10 [symbol] | crystal | | | | 10 [symbol] | 10 [symbol] | |
| | | | | layer 1/Cured | | | | | | |
| | | | | liquid | | | | | | |
| | | | | crystal | | | | | | |
| | | | | layer 2 | | | | | | |
| Example | PET | 50 | 5.0 × | Cured liquid | 2 | 4/4 | 550/550 | 1.9 × | 9.0 × | 1 |
| 3 | | | 10 [symbol] | crystal | | | | 10 [symbol] | 10 [symbol] | |
| | | | | layer 1/Cured | | | | | | |
| | | | | liquid | | | | | | |
| | | | | crystal | | | | | | |
| | | | | layer 2 | | | | | | |
| Example | PC | 50 | 2.0 × | Cured liquid | 2 | 4/4 | 550/550 | 1.9 × | 9.0 × | 1 |
| 4 | | | 10 [symbol] | crystal | | | | 10 [symbol] | 10 [symbol] | |
| | | | | layer 1/Cured | | | | | | |
| | | | | liquid | | | | | | |
| | | | | crystal | | | | | | |
| | | | | layer 2 | | | | | | |
| Example | PET | 50 | 5.0 × | Cured liquid | 2 | 4/4 | 550/550 | 1.9 × | 9.0 × | 1 |
| 5 | | | 10 [symbol] | crystal | | | | 10 [symbol] | 10 [symbol] | |
| | | | | layer 1/Cured | | | | | | |
| | | | | liquid | | | | | | |
| | | | | crystal | | | | | | |
| | | | | layer 2 | | | | | | |
| Example | PET | 50 | 5.0 × | Cured liquid | 1 | 4 | 550 | 1.9 × | 9.0 × | 1 |
| 6 | | | 10 [symbol] | crystal | | | | 10 [symbol] | 10 [symbol] | |
| | | | | layer 1 | | | | | | |
| Example | PET | 50 | 5.0 × | Cured liquid | 2 | 4/4 | 550/550 | 2.3 × | 6.4 × | 0.8 |
| 7 | | | 10 [symbol] | crystal | | | | 10 [symbol] | 10 [symbol] | |
| | | | | layer 3/Cured | | | | | | |
| | | | | liquid | | | | | | |
| | | | | crystal | | | | | | |
| | | | | layer 4 | | | | | | |
| Example | PET | 50 | 5.0 × | Cured liquid | 2 | 4/4 | 550/550 | 1.0 × | 4.5 × | 0.3 |
| 8 | | | 10 [symbol] | crystal | | | | 10 [symbol] | 10 [symbol] | |
| | | | | layer 5/Cured | | | | | | |
| | | | | liquid | | | | | | |
| | | | | crystal | | | | | | |
| | | | | layer 6 | | | | | | |
| Example | PET | 50 | 5.0 × | Cured liquid | 2 | 4/4 | 450/550 | 1.9 × | 9.0 × | 1 |
| 9 | | | 10 [symbol] | crystal | | | | 10 [symbol] | 10 [symbol] | |
| | | | | layer 7/Cured | | | | | | |
| | | | | liquid | | | | | | |
| | | | | crystal | | | | | | |
| | | | | layer 8 | | | | | | |
| Example | PET | 50 | 5.0 × | Cured liquid | 2 | 4/4 | 450/550 | 1.9 × | 9.0 × | 1 |
| 10 | | | 10 [symbol] | crystal | | | | 10 [symbol] | 10 [symbol] | |
| | | | | layer 9/Cured | | | | | | |
| | | | | liquid | | | | | | |
| | | | | crystal | | | | | | |
| | | | | layer 10 | | | | | | |
| Example | PET | 50 | 5.0 × | Cured liquid | 2 | 2/2 | 550/550 | 1.9 × | 9.0 × | 1 |
| 11 | | | 10 [symbol] | crystal | | | | 10 [symbol] | 10 [symbol] | |
| | | | | layer 1/Cured | | | | | | |
| | | | | liquid | | | | | | |
| | | | | crystal | | | | | | |
| | | | | layer 2 | | | | | | |
| Example | PET | 100 | 5.0 × | Cured liquid | 2 | 4/4 | 550/550 | 1.9 × | 9.0 × | 1 |
| 12 | | | 10 [symbol] | crystal | | | | 10 [symbol] | 10 [symbol] | |
| | | | | layer 1/Cured | | | | | | |
| | | | | liquid | | | | | | |
| | | | | crystal | | | | | | |
| | | | | layer 2 | | | | | | |
| Example | PET | 50 | 5.0 × | Cured liquid | 2 | 4/4 | 550/550 | 1.9 × | 9.0 × | 1 |
| 13 | | | 10 [symbol] | crystal | | | | 10 [symbol] | 10 [symbol] | |
| | | | | layer 1/Cured | | | | | | |
| | | | | liquid | | | | | | |
| | | | | crystal | | | | | | |
| | | | | layer 2 | | | | | | |

| | Adhesive layer | | | | | | [symbol] | | | | |
|---|---|---|---|---|---|---|---|---|---|---|---|
| | | Storage | | | | | Reflection | Maximal | | | |
| | | elastic | | | | | bond having | value of | | | |
| | Thickness | modulus | Relationship of | | | Other | maximal value of | reflectivity | Bending | | Durability |
| | d (μm) | E2 [symbol] (Pa) | E1, E2, and E3 | E1-E3 | E3/E2 | Layers | [symbol] (nm) | (%) | resistance | [symbol] | ( [symbol] ) |
| Comparative | 75 | 2.6 × | E1 > | 3.1 × | 0.8 × | — | 550 | 48 | C | B | A |
| Example 1 | | 10 [symbol] | E3 > E2 | 10 [symbol] | 10 [symbol] | | | | 32 [symbol] | [symbol] | 9 nm |
| Comparative | 1 | 1.4 × | E1 > | 3.1 × | 1.4 | — | 550 | 48 | C | B | A |
| Example 2 | | 10 [symbol] | E1 > E2 | 10 [symbol] | | | | | 32 [symbol] | 48% | 3 nm |
| Comparative | 25 | 1.0 × | E1 > | 3.1 × | 2.7 × | — | 550 | 48 | C | B | A |
| Example 3 | | 10 [symbol] | E1 > E2 | 10 [symbol] | 10 [symbol] | | | | 19 [symbol] | 48% | 6 nm |
| Comparative | 5 | 4.9 × | E1 > | 4.9 × | 8.1 × | — | 550 | 48 | C | B | C |
| Example 4 | | 10 [symbol] | E2 > E3 | 10 [symbol] | 10 [symbol] | | | | 16 [symbol] | 48% | [symbol] |
| Comparative | 5 | 4.9 × | E3 > | −1.9 × | 3.9 | — | 550 | 48 | C | B | A |
| Example 5 | | 10 [symbol] | E2 > E1 | 10 [symbol] | | | | | 32 [symbol] | 48% | [symbol] |
| Example | 5 | 9.0 × | E1 > | 3.1 × | 2.1 × | — | 550 | 96 | A | A | A |
| 1 | | 10 [symbol] | E3 > E2 | 10 [symbol] | 10 [symbol] | | | | 4 [symbol] | 96% | 12 nm |
| Example | 5 | 1.0 × | E1 > | 3.1 × | 1.9 × | — | 550 | 96 | A | A | A |
| 2 | | 10 [symbol] | E3 > E2 | 10 [symbol] | 10 [symbol] | | | | 3 [symbol] | 96% | 10 nm |
| Example | 5 | 4.9 × | E1 > | 3.1 × | 3.9 | — | 550 | 96 | A | A | A |
| 3 | | 10 [symbol] | E3 > E2 | 10 [symbol] | | | | | 2 [symbol] | 96% | 8 nm |
| Example | 5 | 4.9 × | E1 > | 0.1 × | 3.9 | — | 550 | 96 | A | A | A |
| 4 | | 10 [symbol] | E1 > E2 | 10 [symbol] | | | | | 2 [symbol] | 96% | 8 nm |
| Example | 31 | 4.9 × | E1 > | 8.1 × | 3.9 | — | 550 | 96 | B | A | A |
| 5 | | 10 [symbol] | E3 > E2 | 10 [symbol] | | | | | 10 [symbol] | 96% | 8 nm |
| Example | 5 | 4.9 × | E1 > | 3.1 × | 3.9 | — | 550 | 48 | A | B | A |
| 6 | | 10 [symbol] | E3 > E2 | 10 [symbol] | | | | | 2 mm | 48% | 8 [symbol] |
| Example | 5 | 4.9 × | E1 > | 2.7 × | 4.7 | — | 550 | 96 | A | A | B |
| 7 | | 10 [symbol] | E3 > E2 | 10 [symbol] | | | | | 2 mm | 96% | 26 mm |
| Example | 5 | 4.9 × | E1 > | 4.0 × | 2.0 | — | 550 | 96 | A | A | C |
| 8 | | 10 [symbol] | E3 > E2 | 10 [symbol] | | | | | 2 mm | 96% | 50 nm |
| Example | 5 | 4.9 × | E1 > | 3.1 × | 3.9 | — | 450/650 | 48/43 | A | B | A |
| 9 | | 10 [symbol] | E3 > E2 | 10 [symbol] | | | | | 2 mm | 48% | 8 nm |
| Example | 5 | 4.9 × | E1 > | 3.1 × | 3.9 | — | 475 | 74 | A | A | A |
| 10 | | 10 [symbol] | E3 > E2 | 10 [symbol] | | | | | 2 mm | 74% | 6 nm |
| Example | 5 | 4.9 × | E1 > | 3.1 × | 3.9 | — | 550 | 76 | A | A | A |
| 11 | | 10 [symbol] | E3 > E2 | 10 [symbol] | | | | | 2 mm | 76% | 6 nm |
| Example | 5 | 4.9 × | E1 > | 3.1 × | 3.9 | — | 550 | 96 | A | A | A |
| 12 | | 10 [symbol] | E3 > E2 | 10 [symbol] | | | | | 2 mm | 96% | 8 nm |
| Example | 5 | 4.9 × | E1 > | 3.1 × | 3.9 | Colored | 550 | 96 | A | A | A |
| 13 | | 10 [symbol] | E3 > E2 | 10 [symbol] | | layer | | | 2 mm | 96% | 8 nm |
| | | | | | | (10 μm) | | | | | |

[symbol]

indicates data missing or illegible when filed

The reflection tint in Table 1 represents a maximal value of the reflectivity in a wavelength range of 300 nm or more and 900 nm or less.

As shown in Table 1, the laminates of Examples were laminates having excellent bending resistance as compared with the laminates of Comparative Examples.

In addition, as shown in Table 1, the laminates of Examples 1 to 13 had excellent lustrousness, and the laminates of Examples 1 to 7 and 9 to 13 had excellent durability.

The disclosure of JP2022-028648 filed on Feb. 25, 2022 is incorporated herein by reference in its entirety. All documents, patent applications, and technical standards described in the present specification are herein incorporated by reference to the same extent that individual documents, patent applications, and technical standards have been specifically and individually indicated to be incorporated by reference, respectively.

What is claimed is:

1. A laminate comprising, in the following order:
a substrate;
an adhesive layer; and
a first cured liquid crystal layer that is formed by curing a liquid crystal layer containing a cholesteric liquid crystal compound,
wherein a storage elastic modulus E1 of the substrate at 25° C., a storage elastic modulus E2 of the adhesive layer at 25° C., and a storage elastic modulus E3 of the first cured liquid crystal layer at 25° C. satisfy E1≥E3>E2, and the E2 is 1.0×10⁵ Pa to 1.0×10⁹ Pa.

2. The laminate according to claim 1,
wherein a storage elastic modulus of the first cured liquid crystal layer in an entire range of 25° C. to 80° C. is 1.0×10⁸ Pa or more.

3. The laminate according to claim 1,
wherein a thickness of the adhesive layer is 3 μm or more and 30 μm or less.

4. The laminate according to claim 1, further comprising:
a second cured liquid crystal layer.

5. The laminate according to claim 1,
wherein the laminate has at least one reflection band having a maximal value of a reflectivity in a wavelength range of 300 nm or more and 900 nm or less.

6. The laminate according to claim 5,
wherein the maximal value of the reflectivity in the reflection band is 40% or more.

7. The laminate according to claim 1,
wherein a crosslinking density of a polymerizable group in the first cured liquid crystal layer is 0.8 mol/L or more.

8. A manufacturing method of a laminate, the method comprising, in the following order:
preparing a composition including a liquid crystal compound having a polymerizable group, an optically active compound, and a photopolymerization initiator;
applying the composition onto a peelable substrate;
curing the composition with light to form a first cured liquid crystal layer; and
laminating the first cured liquid crystal layer on another substrate through an adhesive layer,
wherein a storage elastic modulus E1 of the substrate at 25° C., a storage elastic modulus E2 of the adhesive layer at 25° C., and a storage elastic modulus E3 of the first cured liquid crystal layer at 25° C. satisfy E1≥E3>E2, and the E2 is 1.0×10⁵ Pa to 1.0×10⁹ Pa.

9. A decorative film comprising:
the laminate according to claim 1.

10. An article comprising:
the laminate according to claim 1.

11. A decorative panel comprising:
the decorative film according to claim 9.

12. A display device comprising:
the decorative panel according to claim 11.
